(19) United States
(12) Patent Application Publication
(10) Pub. No.: US 2015/0006269 A1
(43) Pub. Date: Jan. 1, 2015

(54) System for Facilitating Deals Including the Management of Commissions Associated With Referrals

(71) Applicant: Localmaven.com, Inc., New York, NY (US)

(72) Inventor: Sean Michael O'Day, Boca Raton, FL (US)

(21) Appl. No.: 14/313,586

(22) Filed: Jun. 24, 2014

Related U.S. Application Data
(60) Provisional application No. 61/839,480, filed on Jun. 26, 2013.

(51) Int. Cl. G06Q 30/02

(52) U.S. Cl. CPC G06Q 30/0214
USPC 705/14.16

(57) ABSTRACT

A machine based system for facilitating deals is provided that has a memory for storing a list of mavens that assist a vendor in the facilitation of the deal. The list of mavens includes at least one maven that is not an existing customer of the vendor. A voucher for redemption is generated that has information on the deal. A processor is included that determines that the voucher has been redeemed. The processor assigns a commission. The deal may include an incentive for a customer that redeems the voucher.

### CROSS REFERENCE TO RELATED APPLICATION

This application claims the benefit of U.S. Application Ser. No. 61/839,480 filed on Jun. 26, 2013 and entitled, “Method and Apparatus for Facilitating Deals.” U.S. Application Ser. No. 61/839,480 is incorporated by reference herein in its entirety for all purposes.

### FIELD OF THE INVENTION

The present invention relates generally to a machine based system for the management of referrals that facilitate deals between a vendor and a customer. More particularly, the present application relates to system in which a vendor and maven agree on the terms of a deal to be referred, the maven refers a deal to a customer; the customer redeems the deal with the vendor by using the machine based system, and the maven receives for this referral a commission.

### BACKGROUND

The organization of the disorganized economy by the managing of contacts necessary for brand awareness such as advocates, followers, brand ambassadors, fans, etc. is not a trivial process. Certain platforms have been devised to deal with these necessary contacts in different ways. One such platform allows companies to sign up and create a branded page. The company can then start inviting advocates and give these advocates challenges that revolve around advocating the company's product(s) in exchange for a variety of badges and other prizes. Another platform allows brands to drive measurable results through word of mouth (WOM) marketing. However, this platform is focused on social advocacy programs. Yet another platform identifies and activates influencers, focused on helping companies identify and reach out to existing fans in their social networks. A report is created for the companies, either directly or through a marketing agency. This report outlines the influence companies have in their fan base on various social media sites.

Another known platform utilizes a plurality of vendors that refer customers to one another, and a reward is given to a vendor that gives a referral. Although an incentive exists to refer business, the facilitation of a vendor's business is limited in this platform in that the types of deals are not flexible and the network of referral sources is limited to other vendors in the program. An additional platform exists for the facilitation of business in which a customer of a business refers a friend of the customer to the business. If the friend of the customer purchases something from the business, the customer gets a reward. Although this arrangement provides an incentive for an existing customer, it is limited in that only existing customers have an incentive to refer business, and because the types of deals and the modes of distribution of those deals to potential new customers is lacking. There is presently no platform that allows for the creation, communication, and validation of deals in an effective, nimble and highly incentivized manner. Thus, a need exists to overcome the problems with the prior art systems, designs, and processes as discussed above

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended Figs. in which:

FIG. 1 is a diagrammatic view of users of the machine based system.

FIG. 2 is a block diagram of a “sign up” process flow according to an exemplary embodiment.

FIG. 3 is a block diagram of a “create a deal” process flow according to an exemplary embodiment.

FIG. 4 is a landing page of a user of the system.

FIG. 5 is a vendor deal page.

FIG. 6 is a maven voucher page.

FIG. 7 is a maven vendor deal page that shows an exclusive deal type selected.

FIG. 8 is a portion of the maven vendor deal page of FIG. 7, but with the non-exclusive deal type selected.

FIG. 9 is a portion of the maven vendor deal page of FIG. 7, but with the viral deal type selected.

FIG. 10 is a block diagram of a “share a deal” process flow according to an exemplary embodiment.

FIG. 11 is a maven/vendor deal page.

FIG. 12 is a maven/vendor invite a maven page.

FIG. 13 is a maven deal page.

FIG. 14 is a maven invite sub-maven page.

FIG. 15 is a block diagram of a “generate/redeem a voucher” process flow according to an exemplary embodiment.

FIG. 16 is a vendor voucher page.

FIG. 17 is a redeemer voucher page.

FIG. 18 is a block diagram of a “customer voucher request” process flow according to an exemplary embodiment.

FIG. 19 is a maven/vendor customer page.

FIG. 20 is a block diagram of a “network invite” process flow according to an exemplary embodiment.

FIG. 21 is a block diagram of a “accept invitation” process flow according to an exemplary embodiment.

FIG. 22 is a vendor network page.

FIG. 23 is a block diagram of a “commission payment” process flow according to an exemplary embodiment.

FIG. 24 is a vendor finance page.

FIG. 25 is a vendor stats page.

FIG. 26 is a maven finance page.

FIG. 27 is a maven stats page.

FIG. 28 is a block diagram of a “distribution models” process flow according to an exemplary embodiment.

FIG. 29 is a front view of components of the machine based system such as a computer, mobile devices of a vendor, maven, and customer; an email server; and a router.

Repeat use of reference characters in the present specification and drawings is intended to represent the same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

The present invention provides for a machine based system 10, that may create, communicate, and validate deals on the fly. The system 10 may support and automate a business idea based on the insight that thousands of daily deals are already being negotiated and validated outside the formal economy through promoters, intermediaries, commissions and discounts. The arbitrator of such deals has a risk of being disintermediated, and there are no real mechanisms available to measure the effectiveness of these sales channels to the actual providers of the goods and services.

The machine based system 10 automates such transactions, providing tools to vendors, intermediaries, and consumers to continue to manufacture deals, but in a secure and automated way that facilitates lead generation and commission payments and social sharing. In one exemplary embodiment, the system 10 generates income by earning a percentage of all transactions conducted within the system 10. Furthermore, the system 10 can be used to raise funds for charities, summon participants to events, political or otherwise, and in general, facilitate commission based deals.

The machine based system 10 supports Internet-based access and utilizes W3C standards and guidelines. The system 10 supports Internet Explorer (IE) 8, IE9, Firefox 3, Firefox 4, Safari 5, Opera, and Chrome, for example. The system 10 also leverages responsive web standards and guidelines for mobile web/Internet and, in this context, supports IE8, IE9, Firefox 3, Firefox 4, Safari 5, Opera, and Chrome, for example. The system 10 is capable of working within server-based and/or cloudbased environments. The system 10 can also function as a ‘native app’ on all mobile telecommunication device operating systems and can be installed for use on mobile telecommunication devices without accessing a mobile Internet browser or other computer internet browser.

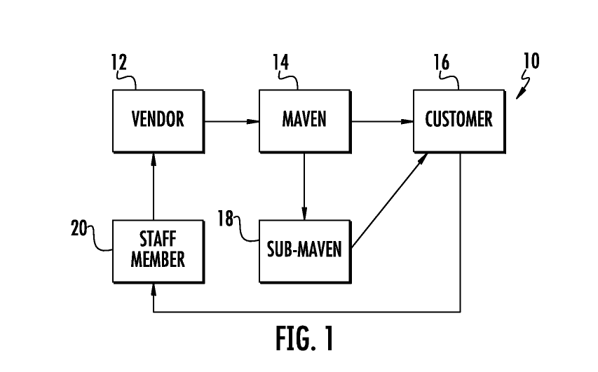

The relationships between users of the machine based system 10 are illustrated with reference to FIG. 1. A vendor 12 is generally a business owner and functions within the system 10 as being able to create deals, pay commissions for sales or closed loop transactions, and manage mavens 14 who represent their deals. The vendor 12 can also assume the role of either customer 16 or maven 14. A maven 14 (who may also be referred to as a promoter) is able to distribute deals, generate unique coupon codes for deals, invite users, and create maven 14 groups. The maven can also assume the role of either vendor 12 or customer 16. In general, the maven 14 promotes a deal of the vendor 12 by going out and finding a customer 16 to accept the offer included in the deal. The customer 16 may be an existing customer of the vendor 12, or the customer 16 may not be an existing customer 16 of the vendor 12 but someone that has never before used the services or purchased the goods of the vendor 12. A maven 14 can also share the potential earnings of a deal by inviting a sub-maven 18 to a deal and share the proceeds of the revenue from the efforts of the sub-maven 18 distributing that deal. The sub-maven 18 may be the actual person to find the customer 16 that accepts the deal when the maven 14 engages the services of the sub-maven 18.

A customer 16 is able to redeem deals provided from mavens 14. The customer 16 can also assume the role of either vendor 12 or maven 14 if the account is upgraded accordingly. In addition, the customer 16 can manage and view deals shared with the customer 16. The customer 16 can also share deals with others via verbal, print, or electronic methods by sharing the unique codes that are generated by the platform representing each unique deal. A redeemer 20, referred to also herein as a staff-member 20, is a user that is “owned” by the vendor 12 and has the ability to view limited details of the vendor 12 account. The redeemer 20 can also validate vouchers as needed against deals owned by the vendor 12. In some arrangements, the maven 14 may validate and thus redeem the voucher. An “administrator” is able to manage system 10 details, and can view and manage users, financials, and system 10 settings. The administrator of the system 10 may be a different person/entity than the vendor 12

The system 10 includes relationship logic and is designed to understand and record relationships as they are generated. Deals are created by users for mavens 14 to share (earning a commission or tracking the referral). Customers 16 can redeem the deals with unique redemption codes that are generated by the system 10 and are unique to each deal. Mavens 14 can generate vouchers with unique tracking codes from deals they represent for potential customers 16. Customers 16 use these vouchers to redeem services/offers from the vendor 12 of the deal. Vendors 12 are allowed to redeem vouchers generated from their deals by entering the unique code from the voucher. This will close the transaction loop and automatically assign a commission as necessary.

The system 10 includes financial transaction capabilities. Integration to payment processing, e.g., using an application programming interface (API) and/or automated clearing house (ACH), is provided to handle payments between mavens 14, vendors 12, and an owner of the system 10. The system 10 enables vendors 12 to track and pay commissions or provide other recognition to mavens 14 due to validated customer vouchers. Payouts will be conducted either weekly or recurring monthly. The system 10 also allows for the tracking of productivity of mavens 14 in a point system manner so that the vendor 12 and maven 14 can quantify the productivity of a maven 14 without assigning a specific monetary value.

The system 10 allows for referral tracking. Vendors 12 and mavens 14 are allowed to track voucher validation with or without commissions involved. The system 10 enables mavens 14 to organize their relationships/contacts into groups to which they can share deals. The commission earnings of the group can go back to the maven 14 or a specific payment account by making the maven 14 account the group account and setting up sub-maven 18 accounts where all or a percentage of the commissions generated go to the centralized maven account. The system 10 also allows for social sharing as the mavens 14 and customers 16 can share a deal on a social media site. Public users can then click-through to see full details of the deal and request a voucher to be generated for them. The system 10 allows mavens 14 to generate unique codes on the fly for deals they distribute to customers 16. With these unique codes, customers 16 can validate services/offers from vendors 12 for proof of redemption.

The system 10 allows for tracking a customer's 16 geographic location if the customer's 16 GPS function is enabled on their wireless device as a method of validating the maven's 14 successful completion of a deal or referral. The system 10 allows for integration of social media. Direct integration to a social media site for social sign up and sign in is provided. This enables user sign up to be quicker and easier to manage. This integration also allows the system 10 to perform data gathering from social media profiles of users.

The system 10 provides short message service (SMS) integration. Direct SMS integration allows alerts and notifications to be sent to users through SMS text messages. The system 10 can also perform its process flow or functions using SMS or “text messages.” When SMS or “text messaging” is employed, a series of codes can be communicated between the system 10 and one or more telecommunication devices without the need for internet access. SMS or text messaging can be used to notify a vendor 12 that a maven 14 has accepted or denied an invitation to a deal, provide a copy of a voucher of a deal to a public user, and/or notify a maven 14 when a voucher has been redeemed.

The system 10 provides email and SMS notifications/alerts. The system 10 can send or can cause email to be sent along with SMS notifications, alerts, and relevant account information to inform and update users. The system 10 provides automatic account creation. If visitors/customers 16 supply their email or phone number to generate a voucher, the system 10 can automatically generate an account for them and provide their account details via email or SMS.

The system 10 uses various APIs. An API is provided to enable integration for social sign up and sign in as well as the data gathering of user profiles. An API is enabled for integration of social sharing. APIs are enabled for a web-based financial transaction to occur between users. An API enables integration to an SMS-based messaging system. An API is enabled to allow emails to be quickly designed and shared. Reports can be generated to inform who is opening, clicking, and viewing the email.

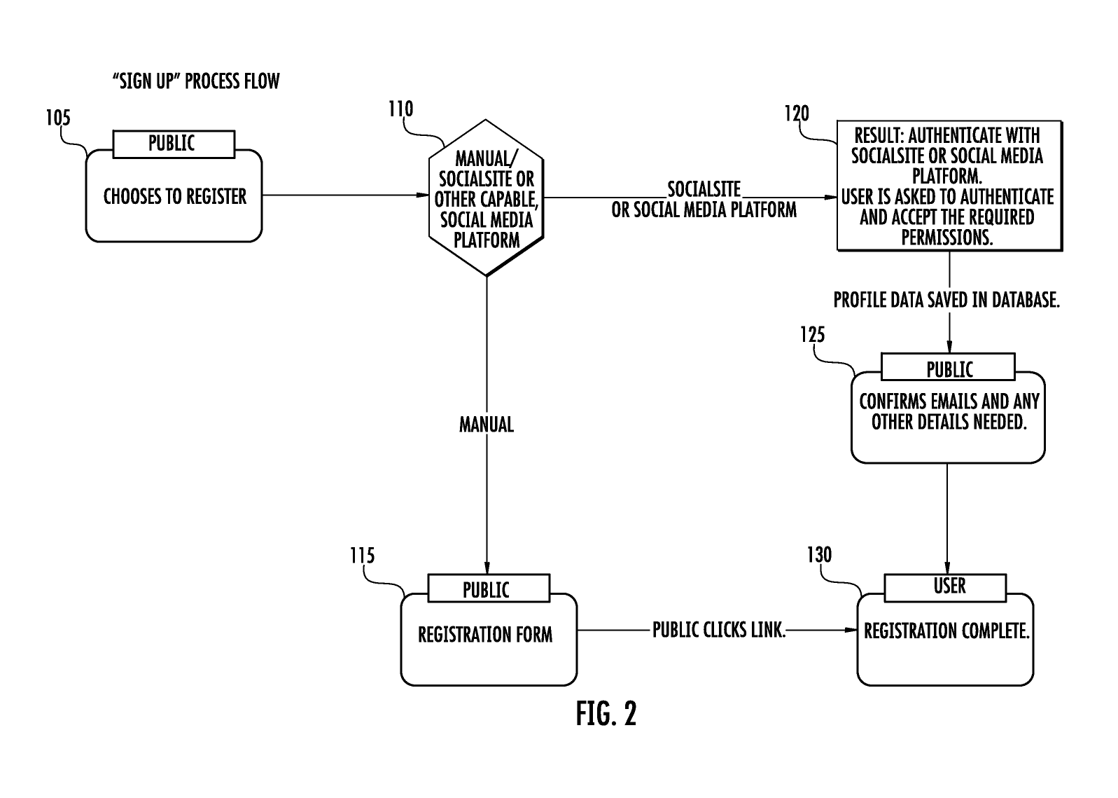

FIG. 2 shows a block diagram of a “sign up” process flow of a first exemplary embodiment. At block 105, a public (non-registered) user chooses to register. At block 110, either manual registration or registration using a social media account of the user is selected. In one embodiment, the social media account of the user is a Facebook® account. If manual registration is selected, the public user completes a registration form at block 115 and clicks a link to complete registration at block 130. If the public user registers using a social media account, the public user is asked to authenticate and accept the required social media site permissions at block 120. The profile data gleaned from the public user's social media account is saved in a database. At block 125 email and any other details needed from the public user are confirmed, and at block 130 registration is completed.

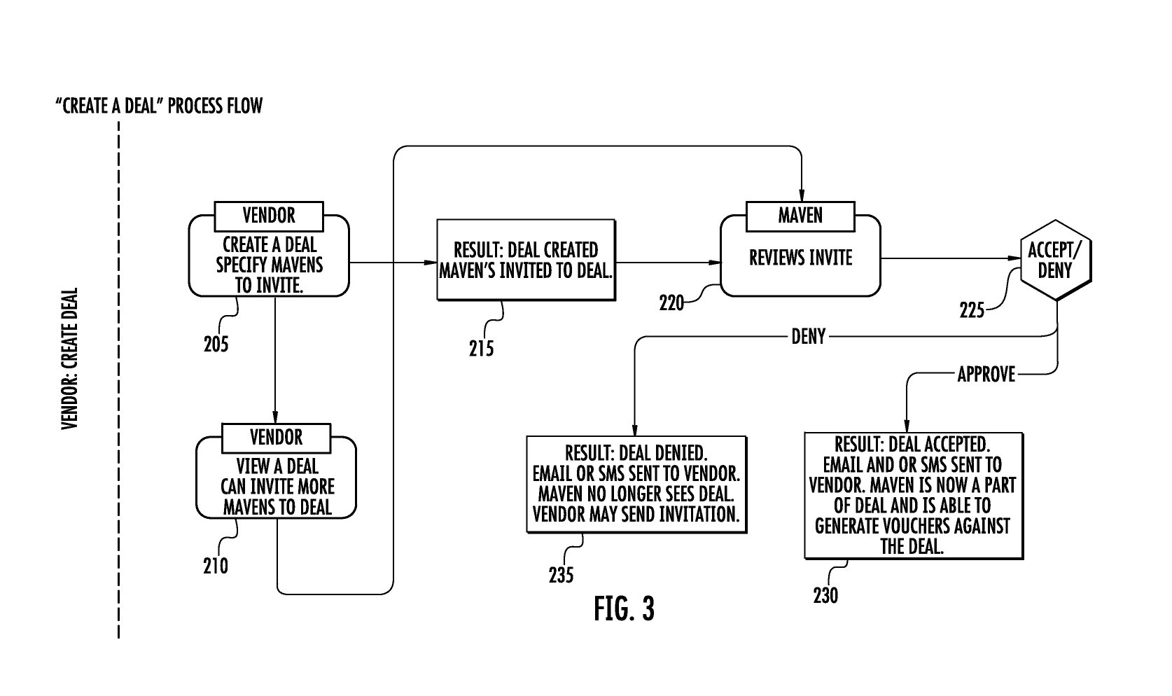

FIG. 3 illustrates a block diagram of an exemplary “create a deal” process flow. At block 205, a vendor 12 creates a deal and specifies mavens 14 to invite. At block 215, the deal is created and the vendor 12 can invite mavens 14 to the deal. The vendor 12 can also view an existing deal and invite more mavens 14 to the deal at block 210. At block 220, the maven(s) 14 review the invite. At block 225, the maven(s) 14 accept or deny the deal. If a deal is accepted, at block 230, an email and/or SMS is sent to the vendor 12. The maven 14 is now a part of the deal and is able to generate vouchers against the deal. If the deal is denied, at block 235, an email or SMS is sent to the vendor 12. The maven 14 no longer sees the deal. The vendor 12 can resend the invitation if desired.

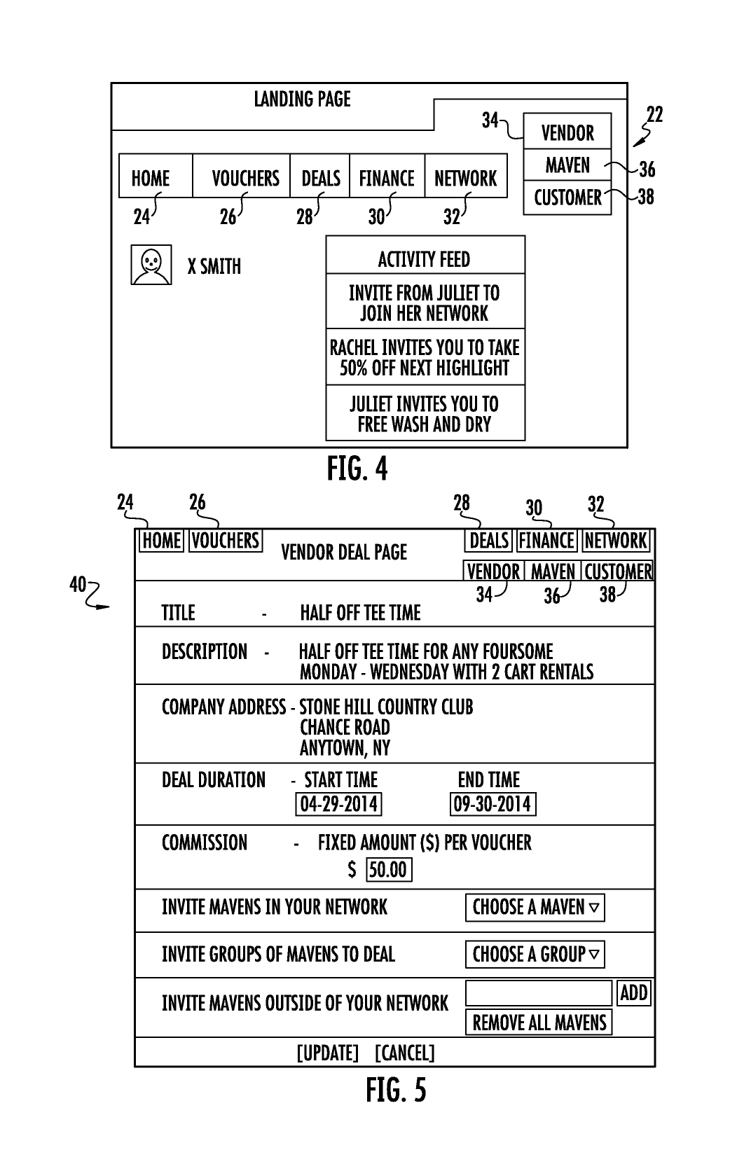

FIG. 4 displays a landing page 22 that is displayed to a user of the system 10 after the user enters his or her login, password, or other authentication credentials. The landing page 22 may be displayed on a display of a computer such as a laptop, desktop, or mobile device. Depending on how the user is set up, a series of assignments 34, 36, and 38 may be presented to the user on the landing page 22. The user may act as a vendor 12, maven 14 and customer 16 with respect to different transactions that are facilitated by the system 10. By selecting the vendor assignment 34, the tabs of the landing page 22 may be reconfigured to allow for capability as a vendor 12. If the user selects the maven assignment 36, the tabs of the landing page 22 can be displayed with information and formatting relevant to the user's role as a maven 14. If the user selects the customer assignment 38, the information displayed on the landing page 22 is again changed to reflect tasks or selections that a customer 16 would use. With respect to FIG. 4, the user has selected the vendor assignment 34 and thus the tabs displayed are those relating to the user's role as a vendor 12. In other arrangements, the user may be set up by the system 10 as having only a single role, for example only as a vendor 12, and thus there is no need for the various assignments 34, 36, 38 as the user cannot select among them.

The landing page 22 also displays a series of tabs that can be selected by the user to cause the system 10 to then present information relevant to the selected tab. The landing page 22 is shown as presenting a home tab 24 that when selected may cause a home page or the landing page 22 to be displayed. The landing page 22 also has a voucher tab 26, deal tab 28, finance tab 30, and network tab 32. Selection of one of these tabs causes a different page to be displayed to the user that is relevant to the subject of the tab. The landing page 22 also has an activity feed that shows news items related to the user on the system 10 such as an invite announcement, a deal offer, a deal advertisement, or an invitation to become a maven 14 for a vendor 12.

If the vendor 12 selects the deal tab 28, a listing of deals that can be active, future, or archived can be displayed. The deal can be created or edited by the vendor 12. FIG. 5 shows the display presented to the vendor 12 when editing a deal that has all ready been created. The vendor deal page 40 has the various tabs and assignments 24, 26, 28, 30, 32, 34, 36 and 38 as previously discussed that can be selected by the vendor 12. The information on the vendor deal page 40 is all directed to a deal that has been created by the vendor 12 and can be edited by the vendor 12 as desired. The vendor deal page 40 has a title of the deal along with a description. The description of the deal includes an incentive for the customer 16 that may be a reduction of price, or free services or product(s). Also presented is an address of the company that is offering the deal. This address may be the vendor 12 address. A deal duration is presented on the page 40 that can be the start time and date of the deal along with the end time and date of the deal. A commission per voucher is also presented to the vendor 12 that could be selected as a percentage of the sales price, or simply a fixed price per voucher. The vendor deal page 40 also has a selection for reaching out to mavens 14 to associate them with the deal that is displayed so that they can promote the deal and help facilitate the deal. The mavens 14 could be selected from the vendors 12 own network, or a group of mavens 14 can be invited to take part in the deal. Additionally, mavens 14 from outside of the network of the vendor 12 can be added through input of their email address or telephone number. The mavens 14 can then be contacted for their invitation. A listing of mavens 14 that have been invited or all ready are a part of the deal may be presented to the user as well. All of the information noted can be changed or updated. If a new deal is desired to be created, a generate deal button can be selected and the discussed information can be added to create the deal as desired.

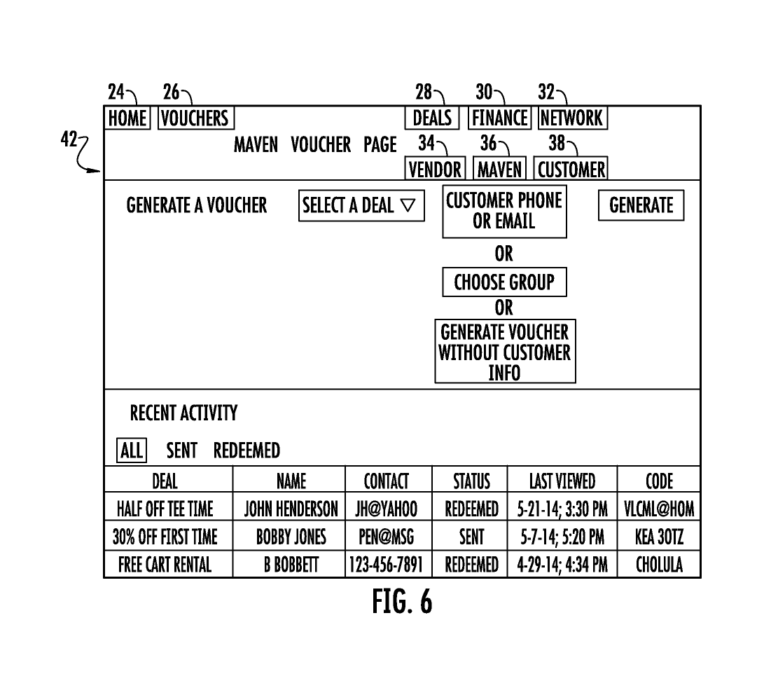

If the user selects the maven assignment 36 to assume his or her role as a maven 14, and then selects the voucher tab 26, the maven voucher page 42 is displayed to the user as shown in FIG. 6. The maven 14 is presented with a generate voucher action where the user can actuate a drop down list to select a deal that is assigned to the maven 14 or is otherwise available to the maven 14. The customer's 16 phone number or email address can be entered so that the specific customer 16 can be identified. Alternatively, a group of customers 16 can be selected, or the voucher can be generated without having any customer 16 information. A generate voucher button may be selected by the maven 14 to cause the voucher to be generated. The maven voucher page 42 also has a display of voucher activity that can be sorted by those vouchers sent, those vouchers redeemed, or by all. The displayed information includes the name of the deal, the name of the customer 16 to whom the voucher was sent, the customer's 16 contact information, the status on the voucher as to whether it was or was not redeemed, the date and time the voucher was last viewed, and the redemption code associated with the voucher in question.

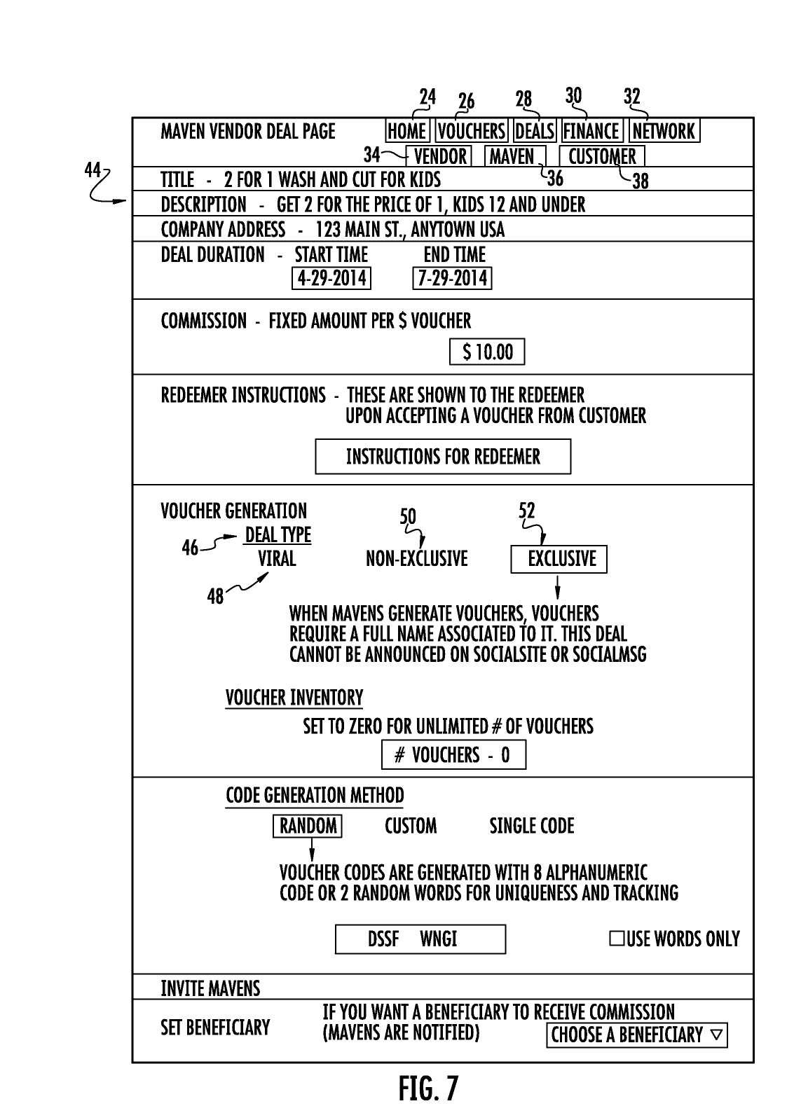

Another maven vendor deal page 44 is illustrated with reference to FIG. 7 that could be used in any portion of the system 10 in which one of the users desires to create a deal. The maven vendor deal page 44 may be accessed through selection of the deal tab 28, and then selecting generation of a deal or editing of an existing deal from that screen. The maven vendor deal page 44 includes title, description, company address, deal duration, and commission information as previously discussed with respect to the vendor deal page 40 and a repeat of this information is not needed. The maven vendor deal page 44 has a redeemer instruction section in which instructions for a redeemer/staff-member 20 of the deal can be entered. These instructions are presented to the redeemer/staff-member 20 when the customer 16 redeems the deal so that the deal can be properly facilitated.

Also included on the maven vendor deal page 40 is a voucher generation section in which a deal type 46 can be selected by the vendor 12. This feature allows for greater flexibility in the creation and generation of the deal so that the system 10 can better facilitate deals and tailor them in an appropriate fashion. Some deal types 46 may have a better chance of being accepted by the customer 16 than other deal types 46. By crafting the deal though designation of a particular deal type 46, greater success can be achieved by the system 10. The deal type selected in the maven vendor deal page 44 is the exclusive deal type 52. With the exclusive deal type 52, the voucher that is generated requires a full name of the customer 16 be associated with the voucher. The full name may simply be the first and last name of the customer 16, and need not include the middle name or initial. In other arrangements, the middle name or middle initial is in fact included in the full name of the customer 16. The exclusive deal type 52 upon voucher generation is thus focused onto, and specific to, an identified customer 16. The exclusive deal type 52 cannot be announced on FACEBOOK® or TWITTER® but instead must be communicated in person, or though an SMS message, or email, or other non-social network means to the customer 16. The voucher generation section of the page 44 may also have a voucher inventory selection. Here, the vendor 12 can select how many vouchers are allowed to be generated for the deal that is being generated or edited in question. If the vendor 12 selects 0, then an unlimited number of voucher may be generated for facilitation of the deal.

The maven vendor deal page 44 also includes a code generation section in which a redemption code can be created and assigned to the voucher that is generation with respect to the deal. The code generation method may be random, custom, or a single code. A random code is assigned to the voucher and may be two random words only, or a code made up of 8 alpha numeric letters/numbers. A custom code is input by the vendor 12 to be assigned to the vouchers generated for the deal. A single code selection means that when the maven 14 accepts the deal invitation, the redemption code (random or custom) will be assigned to that maven 14. This code may be used by all vouchers generated by the maven 14 associated with that particular deal.

The maven vendor deal page 44 also has an invitation means that allows the vendor 12 to determine how to invite mavens 14 to accept the deal. Also, a beneficiary can be selected for the deal. In this regard, any commission earned by the maven 14 can go to the selected beneficiary instead of to the maven 14 that facilitates the deal. The beneficiary may be a person that does not help facilitate the deal, and may be a person that does not find the customer 16 that accepts the deal. This option may be helpful when the deal involves a charity or other worth cause. The maven 14 can be notified when the commission is to be assigned to a beneficiary. In some arrangements, the commission can be set up so some of it goes to the beneficiary and so that some of it goes to the maven 14.

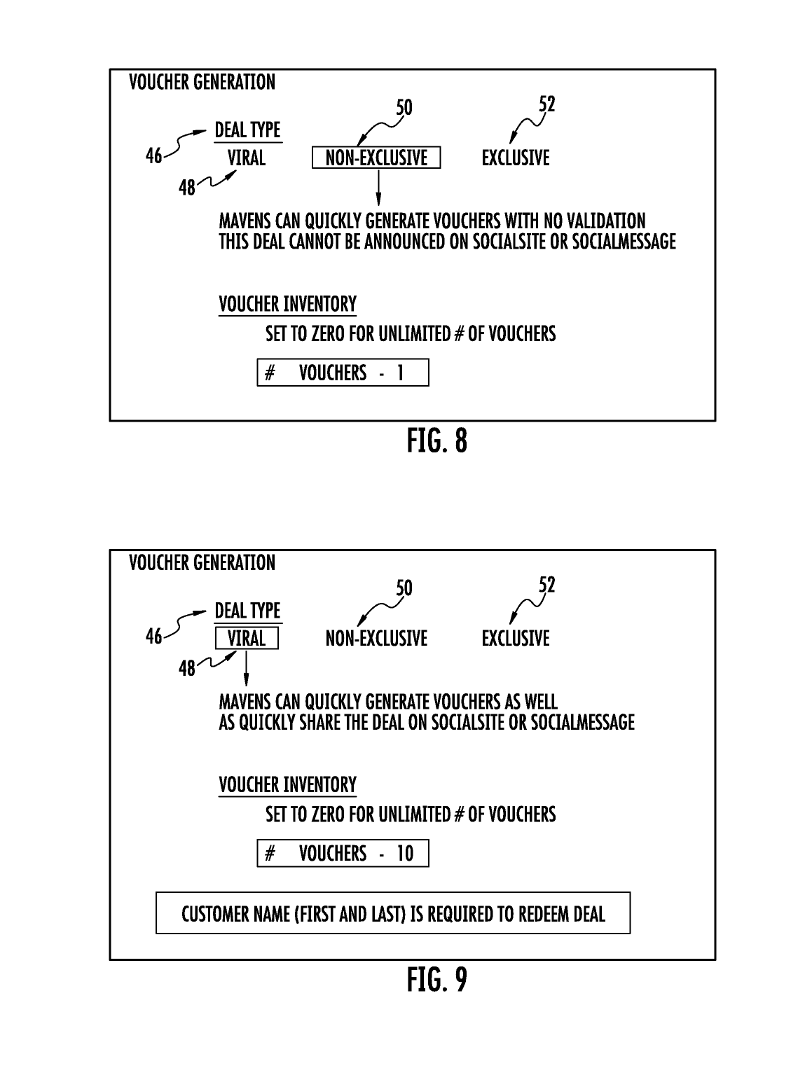

FIG. 8 shows just the voucher generation portion of the maven vendor deal page 44 when the deal type 46 is selected as a non-exclusive deal type 50 instead of the exclusive deal type 52 as in FIG. 7. The non-exclusive deal type 50 does not require the full name of the customer 16, and may not require any identifying features of the customer 16. The non-exclusive deal type 50 may be a voucher that is generated without validation. The non-exclusive deal type 50 cannot be announced on FACEBOOK® or TWITTER®. The non-exclusive deal type 50 may not be announced on any social media platform in some exemplary embodiments. The non-exclusive deal type 50 may be communicated by the maven 14 to the customer 16 by way of in person communication, paper letter, email, or SMS messaging. The voucher inventory is set to 1 in this exemplary embodiment which means that only one voucher for this deal can ever be created. However, the user may modify this single voucher selection in the future if desired.

FIG. 9 shows just the voucher generation portion of the maven vendor deal page 44 of FIG. 7. The voucher generation portion in FIG. 9 has a different deal type 46 selected than that shown in FIG. 7. As with FIG. 8, the rest of the maven vendor deal page 44 can be as that previously presented and a repeat of this information with respect to FIGS. 8 and 9 is not necessary. The deal type 46 selected in the detailed portion of FIG. 9 is the viral deal type 48. The viral deal type 48 can be shared on FACEBOOK® and TWITTER® and any other social media site. FACEBOOK® and TWITTER® are social media internet sites in which a user has connections to other users of the site for purposes of exchanging information with these other users. The viral deal type 48 can also be communicated to the customer 16 by any other conceivable channel such as paper letter, in person communication, email, or SMS message. With the paper letter or in person communication the voucher can be printed out and handed to the customer 16. Also, the voucher can be delivered orally to the customer 16 over the telephone or in person. The full name of the customer 16 (first and last) is needed in order for the customer 16 to be able to redeem the deal. The customer 16 will have to provide his or her full name upon redemption.

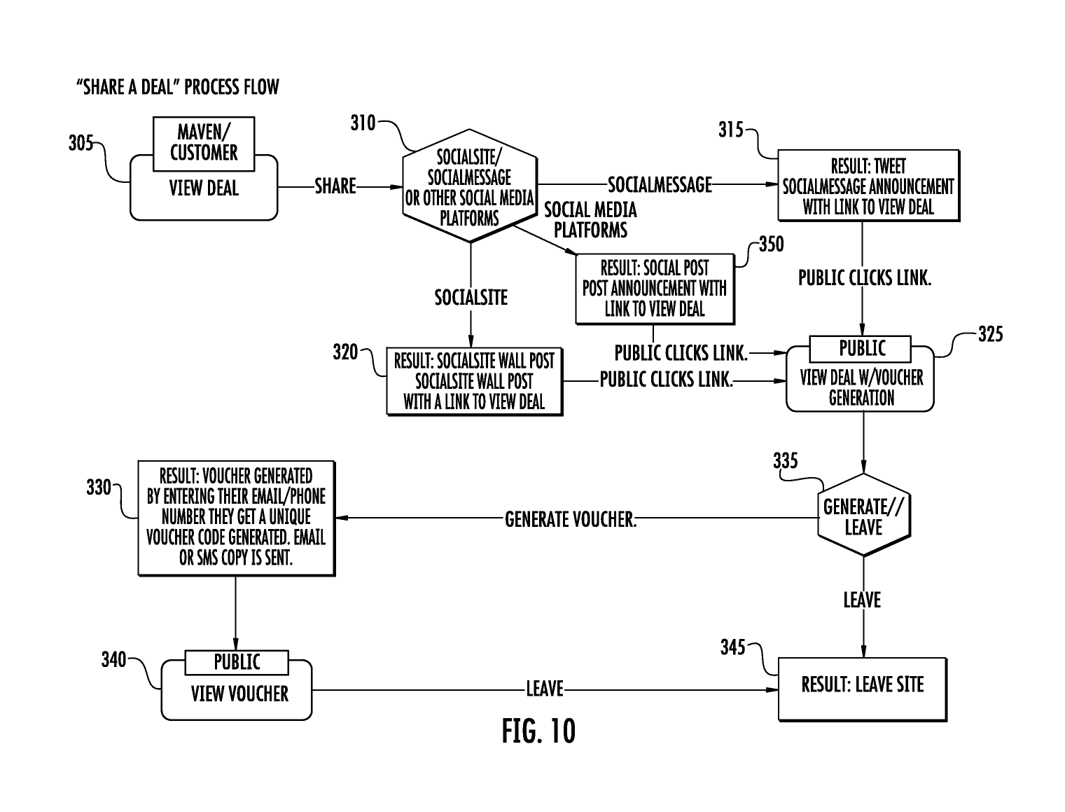

FIG. 10 is a block diagram of an exemplary “share a deal” process flow. At block 305, a maven 14 or customer 16 views a deal. At block 310, the maven 14 or customer 16 shares the deal using social media. The deal can be shared using a wall post at block 320, a social post at block 350, or an announcement at block 315. When a public user sees the deal on the social media site they are able to click on a link for the deal. At block 325, the public user is allowed to view the deal and generate a voucher. At block 335, the public user selects whether to generate a voucher or leave the deal site. When the public user decides to generate a voucher, at block 330, a unique voucher code can be generated when the public user enters an email address or phone number. An email copy or SMS is sent to the public user. The public user can view the voucher at block 340. When the public user decides to leave the site, this occurs at block 345.

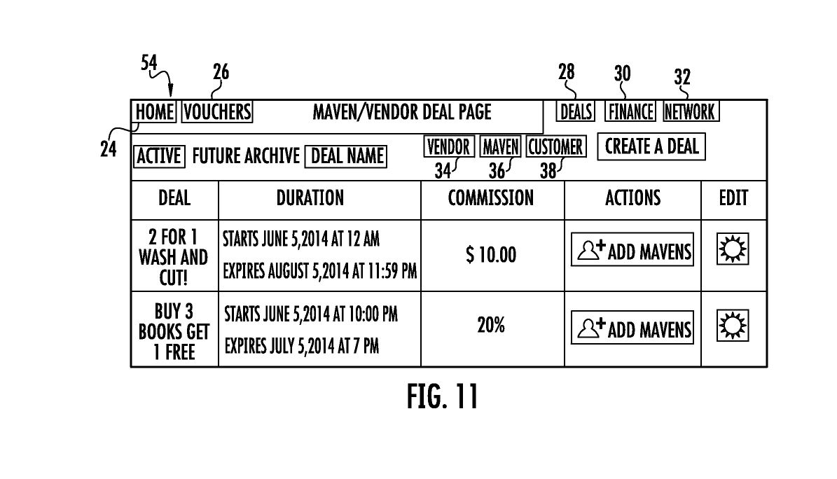

FIG. 11 shows a maven vendor deal page 54 that may be presented to a maven 14 or a vendor 12 upon selection of the deal tab 28. The maven vendor deal page 54 includes a create a deal button that can be selected to create a deal, and one or more edit buttons that can be selected to edit all ready existing deals. Selection of either of these two buttons may cause the displays previously discussed with respect to FIGS. 5, and 7-9 to be presented to the user to allow him or her to create a new deal or edit an all ready existing deal. The maven vendor deal page 54 is shown in FIG. 11 as the display presented to a vendor 12 upon selection of the deal tab 28. The deals that have been created and are offered by the vendor 12 are displayed in list form. The vendor 12 can select from active deals, future deals, and archive deals. If the archive deals are selected, deals are listed in the display that have expired. If the future deals are selected, deals are instead listed in the display that have not yet begun but have been created and will become redeemable at some point in the future. The active deals are selected in FIG. 11 and these are current deals that are currently being offered and can be redeemed by the customer 16. The displayed list shows an image that is representative of the deal and the title of the deal, a duration field that shows when the deal starts and when the deal ends, a commission field that shows the amount of commission that must be paid by the vendor 12 when the deal is taken advantage of, an actions field that has in this example selection buttons that allows one to invite a maven 14 to pick up and promote the deal, and an edit button that allows one to edit the deal as previously discussed.

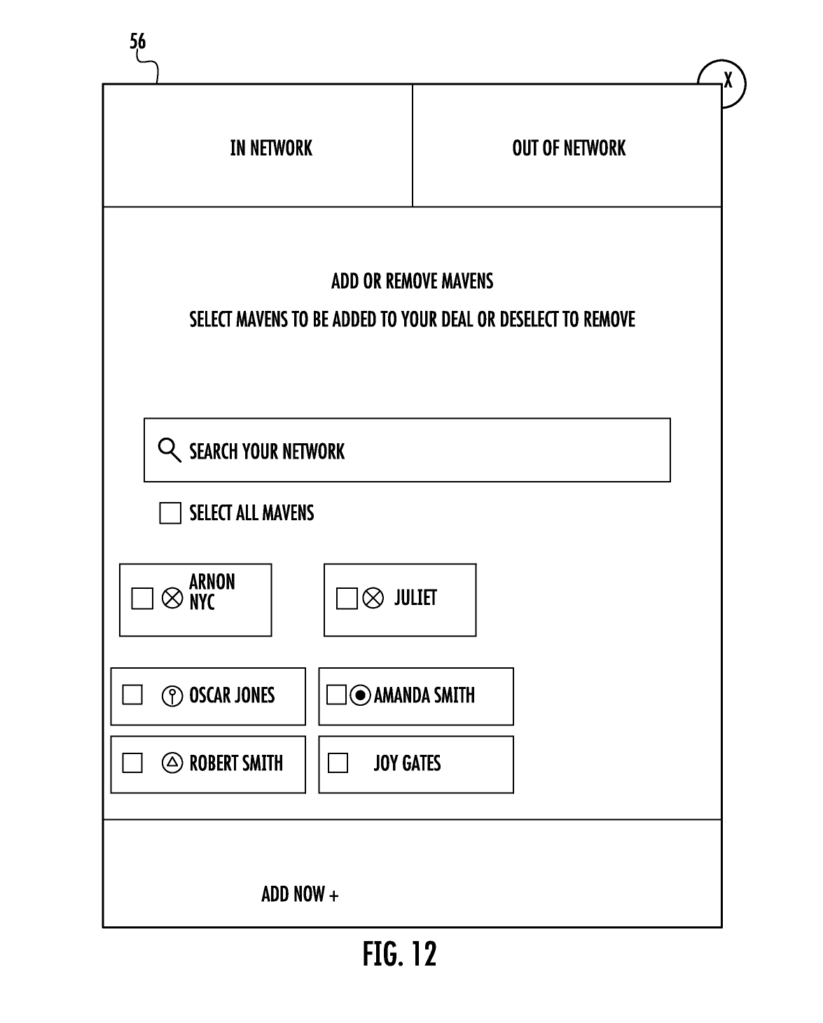

If the vendor 12 clicks onto the “add mavens” “+” button on the invite maven selection for a particular deal, the display may then move to a maven/vendor invite maven page 56 as shown in FIG. 12. The vendor 12 is first presented with an In Network/Out of Network selection, and the In Network selection is made and shown in FIG. 12. A list of mavens 14 that are in the network of the vendor 12 are presented for display with a check box next to each one. A search field is also present in order to allow the vendor 12 to search for a particular maven 14. The vendor 12 may select certain mavens 14, or may select all of the mavens 14 that are in network through the selection of a “select all mavens” button. Once the desired mavens 14 are selected, they user will click the “add now +” button in order to add these selected mavens 14 to the deal.

If the vendor 12 clicks on the Out of Network selection, a different box may be displayed to the vendor 12 instructing him or her to enter a telephone number or email address. Once done, the machine based system 10 will send an invite to the telephone number or email address entered. This type of invite is used for desired mavens 14 that are not within the network of the vendor 12.

If the user selects the maven assignment 36 to identify himself or herself as a maven 14 for use of the system 10 in this mode, and then selects the deal tab 28, the maven deal page 58 is presented to the user as shown in FIG. 13. The maven 14 can search for a deal using the search feature shown, or can display deals that are assigned to the maven 14. The maven 14 can display these deals by selecting the active, pending acceptance, or archive selections. If archive is chosen, deals that were assigned to the maven 14 in the past that are now expired are displayed. If the maven 14 selects the pending acceptance tab, the deals that the vendor 12 has invited the maven 14 to promote are displayed. These deals are those that have not yet been accepted by the maven 14 but are awaiting acceptance. The active tab is the one that is selected in FIG. 13 and doing so causes the display shown to be presented that has an image that symbolizes the deal, the title of the deal, an action button that allows a sub-maven 18 to be invited by the maven 14 into that particular deal, a generate a voucher action for that particular deal, and options to share the deal to social media sites such as FACEBOOK® and TWITTER®. Some deals, such as those that are of the non-exclusive deal type 50 or the exclusive deal type 52, cannot be shared on social media sites and this fact is also displayed in the list shown.

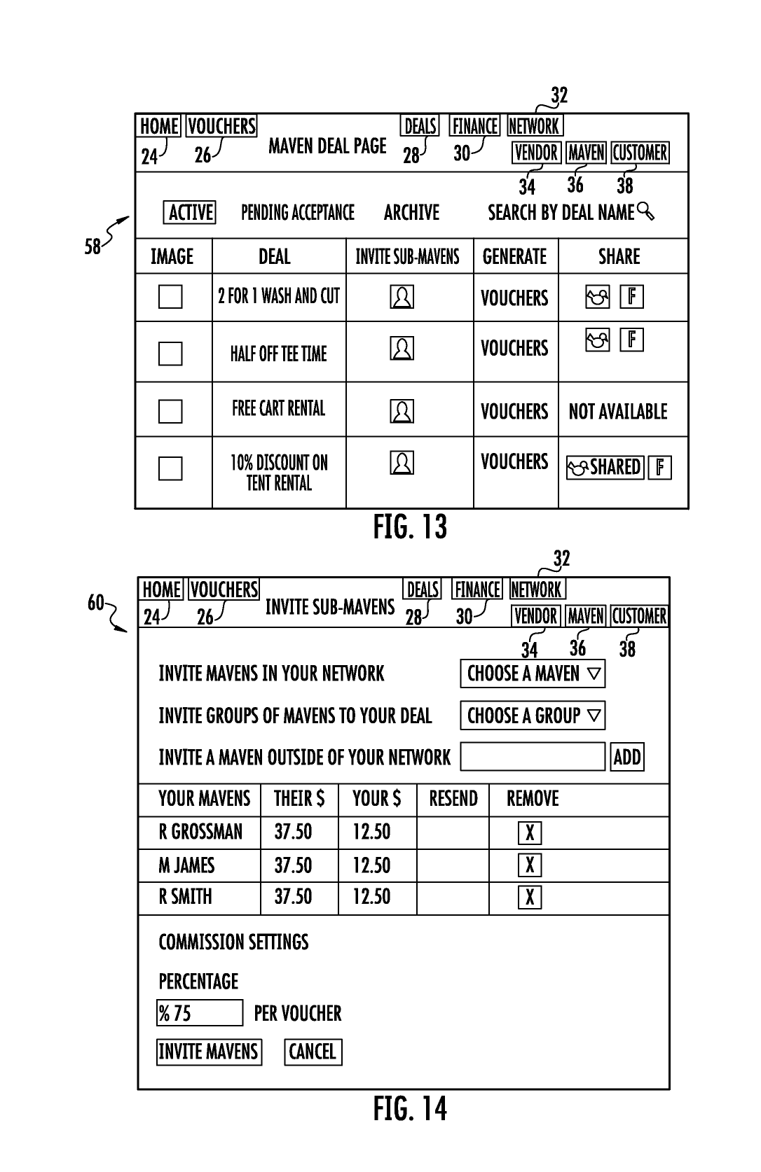

If the maven 14 selects one of the invite sub-maven tabs then the maven 14 is presented with the invite sub-maven page 60 as shown in FIG. 14. On this page, the maven 14 can search, his or her network on the system 10 for sub-mavens 18. Alternatively, a maven's 14 contact email list or social media friends or contacts may be within the maven's network and they can be added in this manner. The maven 14 may also invite a group of mavens 14 to the deal, or may use a phone number, email address, or other contact information to invite sub-mavens 18 that are outside of the network of the maven 14.

The page 60 also has a listing of the sub-mavens 18 of the maven 14 for the deal in question, the amount of commission the sub-maven 18 will receive for the deal, the amount of commission the maven 14 will receive for the deal, whether an invitation to a sub-maven 18 that has not yet accepted the request of being a sub-maven 18 should be resent, and an option to remove the sub-maven 18 from the maven's 14 list. The invite sub-maven page 60 also has a commission settings page in which the maven 14 determines for that voucher how much of the commission will be given to the sub-maven 18. The maven 14 enters a percentage of the commission that he or she wants to give to the sub-maven 18 for promoting the deal that the maven 14 is assigned.

In an alternative exemplary embodiment, upon selection of the invite sub-maven button, a display similar to that shown in FIG. 12 can be presented to the maven 14. The maven 14 can invite a sub-maven 18 from his or her network, or can use the out of network feature as discussed above with reference to FIG. 12 and a repeat of this information is not necessary.

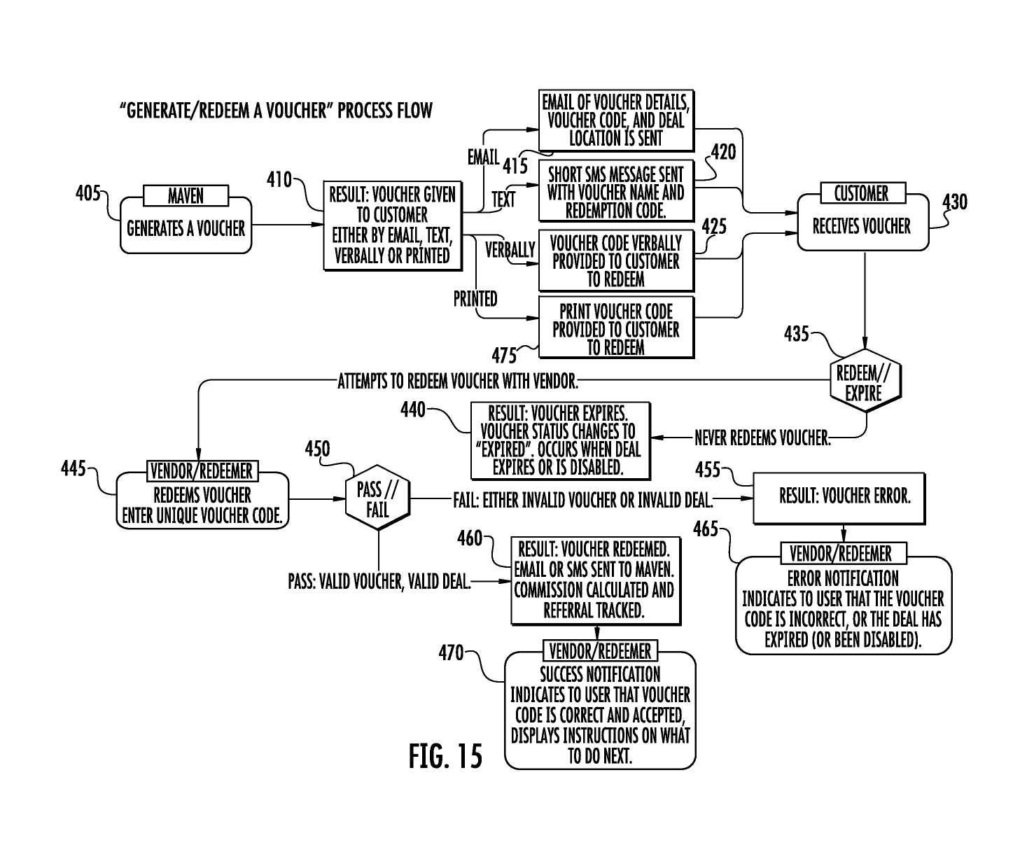

FIG. 15 illustrates a block diagram of an exemplary “generate/redeem a voucher” process flow in accordance with one embodiment. At block 405, a maven 14 generates a voucher. At block 410, the voucher can be given to a customer 16 either by email, text, print, or verbally. At block 415, when email or SMS is used, an email of voucher deals, a voucher code, a deal location, and any other relevant deal information and details are sent. At block 420, when text is used, a short SMS message is sent with the voucher name, other relevant deal details, and a redemption code. At block 425, when the deal is communicated verbally, the voucher code is verbally provided to the customer 16 for redemption by the customer 16. At block 475, when the deal is printed, the voucher code is printed and provided to the customer 16 for redemption by the customer 16. In addition to the voucher code, the print-out may include deal location and any other relevant information/details. The customer 16 receives the voucher at block 430. At block 435, the voucher is either redeemed or is allowed to expire. At block 440, when the voucher expires, a voucher status changes to “Expired.” This occurs when the deal expires or is disabled. At block 445, the vendor 12 or redeemer/staff-member 20 redeems the voucher by entering a unique voucher code. The voucher code either passes or fails at block 450. A voucher code failure occurs when there is an invalid voucher or an invalid deal. At block 455, a voucher error results. At block 465, an error notification is provided to the vendor 12 or redeemer/staff-member 20. The error notification indicates to the user that the voucher code is incorrect or the deal has expired (or been disabled). At block 460, a valid voucher and valid deal have been indicated and the voucher is redeemed. An email or SMS is sent to the maven 14. A commission is calculated and the referral is tracked. At block 470, the vendor 12 or redeemer/staff-member 20 receives a success notification. This successful notification indicates to the user that the voucher code is correct and accepted. Instructions are also displayed on what the user needs to do next.

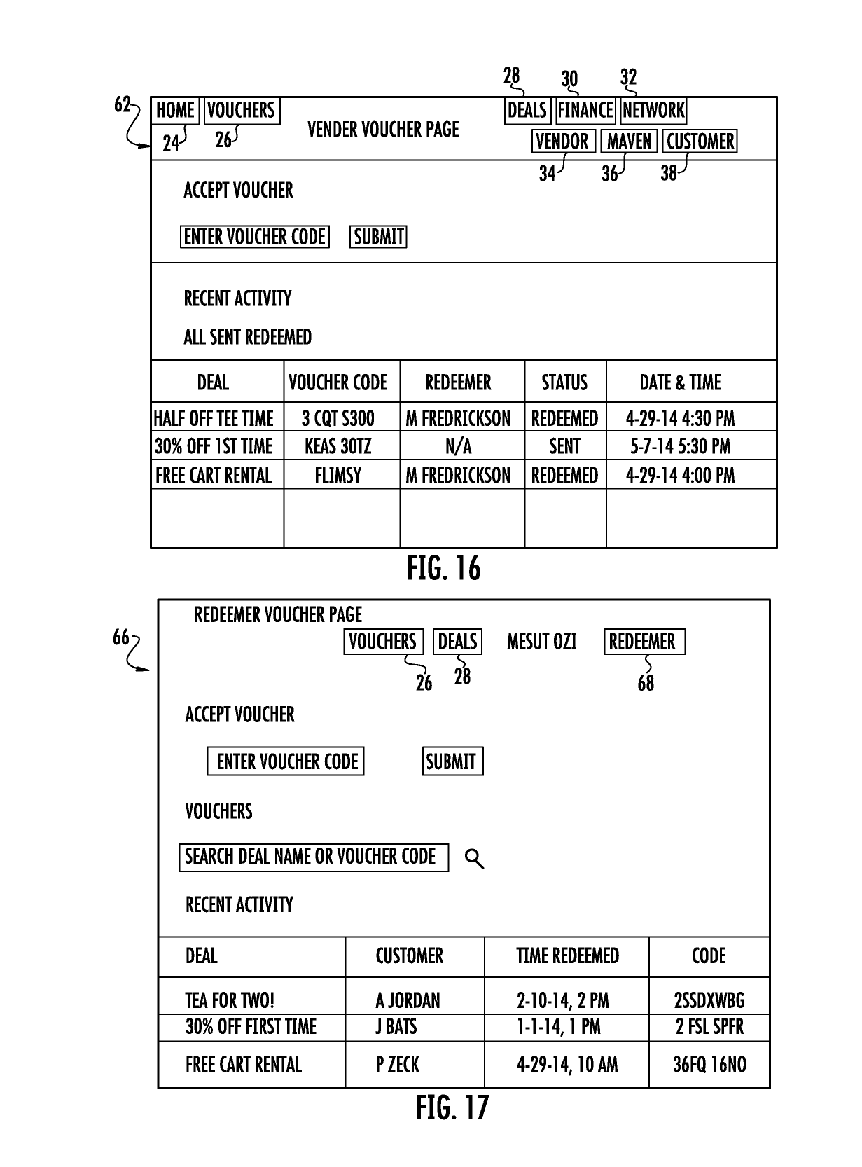

If the user is a vendor 12, or otherwise clicks on the vendor assignment 34 and then subsequently selects the voucher tab 26, the vendor voucher page 62 is displayed to the vendor 12 on the display of the vendor 12 as shown in FIG. 16. An accept voucher field is present in which the vendor 12 can enter the voucher code that the vendor 12 is given. If the voucher code 12 is correct, the voucher is authenticated and redeemed, if the voucher code 12 is not recognized by the system 10 an error message saying so it displayed and the voucher is not redeemed. The page 62 also includes a display of recent activity that can be organized by all, sent, or redeemed. “All” is selected by the vendor 12, and a list is displayed that shows the title of the deal, the voucher code that was generated for that deal, the redeemer/staff-member 20 that redeemed the deal, the status of the deal as to whether it was redeemed or if it was only sent, and the date and time that the deal was redeemed or sent if it was not yet redeemed. If the deal was only sent, then no redeemer/staff-member 20 is listed for that deal. These types of deals have a voucher that was generated and sent, but not yet redeemed. If the user selects “sent” then only those deals that were sent but not yet redeemed are listed, and if “redeemed” is selected only those deals with the redeemed status are displayed in the list.

If the user is a redeemer/staff-member 20, the user may authenticate himself or herself on the system 10 and then be presented with the redeemer voucher page 66 as shown in FIG. 17. The redeemer/staff-member 20 may only have the voucher tab 26 and deals tab 28 presented for selection as his or her use of the system 10 may be limited mainly to just the redemption of deals. The redeemer/staff-member 20 can enter a voucher code and click “submit” to allow the system 10 to search to see if the voucher code is valid or not valid. The page 66 also allows for the searching of a deal upon entering the deal, and for the searching of a particular voucher upon entry of a voucher code into a search field. The recent activity of the redeemer/staff-member 20 may also be shown that can include the title of the deal, the customer 16 that accepted and redeemed the deal, the time the deal was redeemed, and the voucher code. The redeemer/staff-member 20 may be an employee of the vendor 12 that works for the vendor 12 by entering voucher codes into the redeemer voucher page 66 for redemption. The redeemer/staff-member 20 is shown in FIG. 17 as having only a single assignment, that being the redeemer assignment 68. However, in other arrangements the redeemer/staff-member 20 could also be a maven 14, or a customer 16 and may additionally have those assignments 36, 38 on the page 66 that can be selected for functionality as one of those two user types as well.

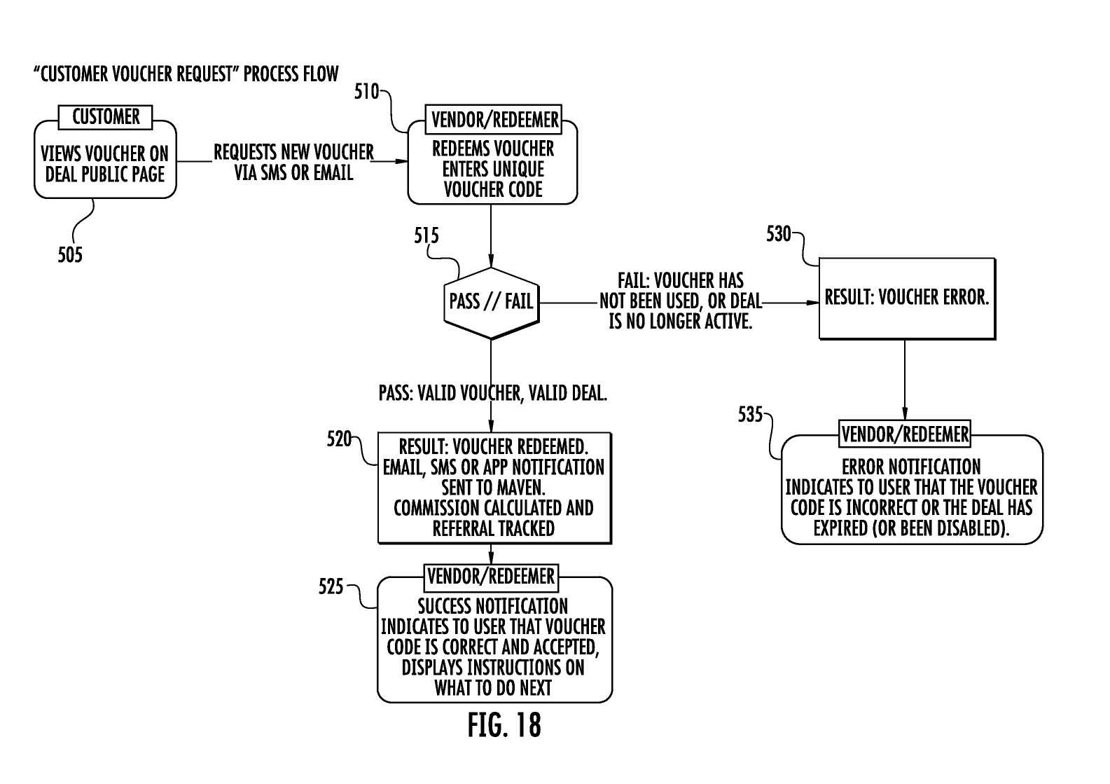

FIG. 18 is a block diagram of an exemplary “customer voucher request” process flow. At block 505, a customer 16 views a voucher on a deal public page. The customer 16 requests a new voucher to be sent via SMS or email. At block 510, the vendor 12 or redeemer/staff-member 20 redeems the voucher and enters a unique voucher code. At block 515, the voucher code passes or fails. At block 520, when there is a valid voucher and valid deal, the voucher is redeemed. An email, SMS, or application notification is then sent to the maven 14. A commission is calculated as well and the referral is tracked. At block 525, the vendor 12 or redeemer/staff-member 20 receives a success notification. This success notification indicates to the user that the voucher code is correct and accepted. Instructions are then displayed on what to do next.

When the deal fails, e.g., the voucher has not been used or the deal is no longer active, a voucher error is received at block 530. At block 535, the vendor 12 or redeemer/staff-member 20 receives an error notification. This error notification indicates to the user that the voucher code is incorrect, or the deal has expired (or been disabled).

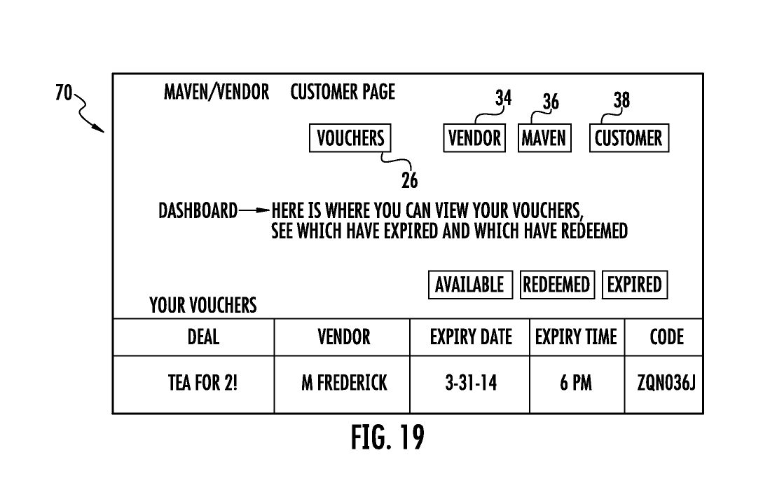

A customer 16 that logs into the system 10 may be presented with a customer page 70 such as the one shown in FIG. 19. The customer 16 may be a registered user that is both a maven 14 and a vendor 12 but is also a customer 16. The various assignments 34, 36 and 38 may be presented to the user and he or she may click on the customer assignment 38 to function as a customer 16. Alternatively, the customer 16 may only be a customer 16 with respect to the system 10 and cannot assume any other role. The customer 16 may be presented with information on the customer page 70 about how to upgrade to a vendor 12 or maven 14 if desired.

The customer page 70 has a voucher tab 26 that can be clicked on to display a dashboard of the customer 16 that provides information on the vouchers of the customer 16. The display can be of vouchers that are available, redeemed, and expired and buttons for the selection of one of these three are presented. The available button is chosen in FIG. 19 and this shows the vouchers that the customer 16 presently has and can redeem if he or she desires. The display shows the title of the deal, the vendor 12 that made the deal the customer 16 wants to accept, the expiration date of the voucher, the expiration time of the voucher, and the authorization code for that deal. If the customer 16 hits the “redeemed” button the display changes to show vouchers that have been redeemed by the customer 16 with the same categories as previously discussed. In a similar manner, if “expired” is selected the same categories remain but the information is replaced with those vouchers of the customer that have expired and that can no longer be redeemed.

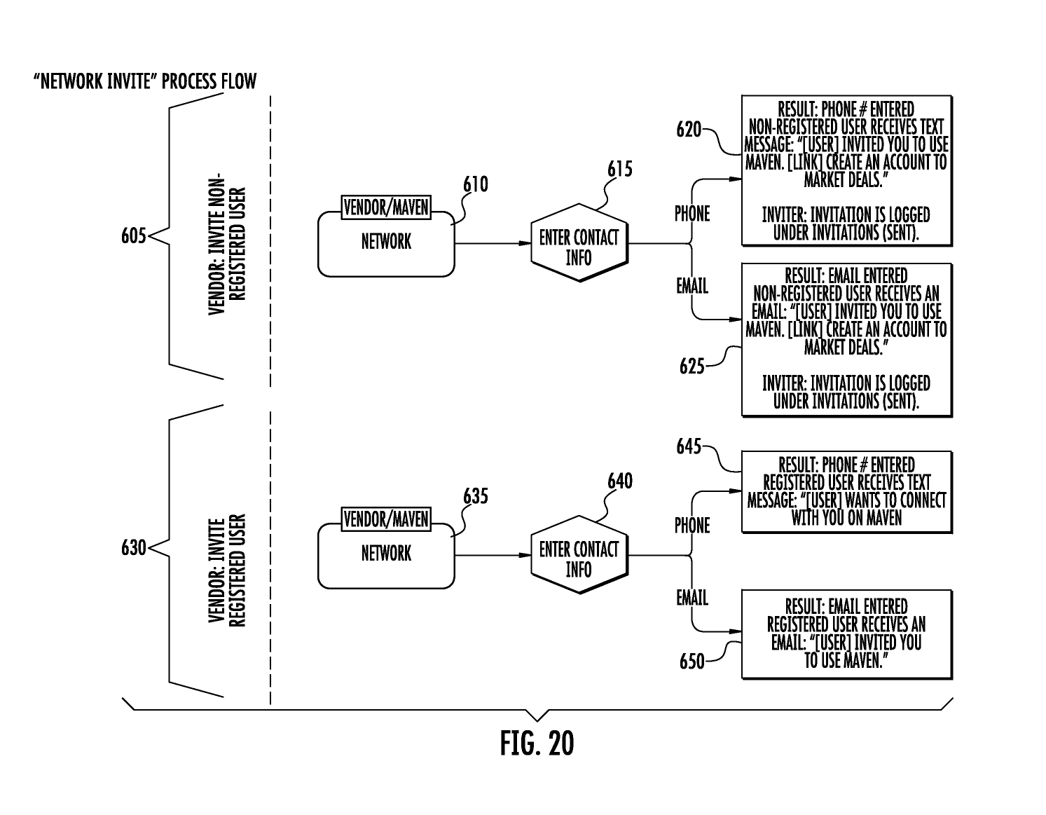

FIG. 20 is a block diagram of an exemplary “network invite” process flow. An invitation can be sent to a non-registered user 605 or a registered user 630. At block 610, a vendor 12 or maven 14 invites a non-registered user to the network. Contact information for the non-registered user is entered at block 615. When phone information is entered at block 620, the non-registered user receives a text message. An example message can be: “[User] invited you to use maven [link]. Create an account to market deals.” The invitation is logged under Invitations (Sent) for the inviter. When email information is entered at block 625, the non-registered user receives an email or SMS. An example email or SMS message can be: “[User] invited you to use Maven [link]. Create an account to market deals.” The invitation is logged under Invitations (Sent) for the inviter. At block 635, a vendor 12 or maven 14 invites a registered user to the network. Contact information for the non-registered user is entered at block 640. When phone information is entered at block 645, the registered user receives a text message. An example message can be: “[User] wants to connect with you on Maven.” When email or SMS (mobile phone or other method of receiving SMS messages) information is entered at block 650, the registered user receives an email or SMS. An example email message can be: “[User] invited you to use Maven.”

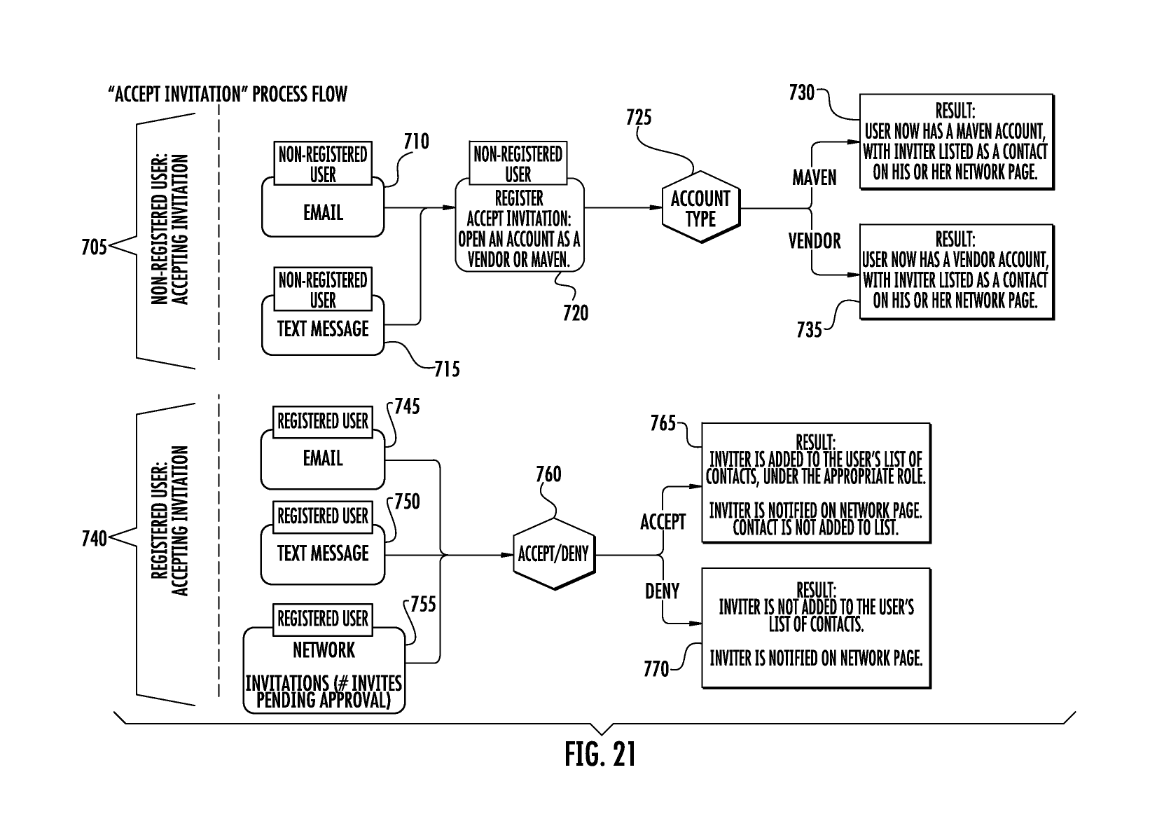

FIG. 21 is a block diagram of an exemplary “accept invitation” process flow. An invitation can be accepted from a non-registered user 705 or a registered user 740. The non-registered user accepts the invitation by email at block 710 or by text message at block 715. At block 720, the system 10 registers the accepted invitation of the nonregistered user. The non-registered user can open an account as a vendor 12 or maven 14. At block 725, an account type is selected by the user. When the user selects a maven 14 account at block 730, the user now has a maven 14 account with the inviter listed as a contact on his or her network page. When the user selects a vendor 12 account at block 735, the user now has a vendor 12 account with the inviter listed as a contact on his or her network page.

For a registered user, the invitation can be accepted by email at block 745, text message at block 750, or through the network page of the registered user at block 755. At block 760, the registered user can accept or deny the invitation. When the registered user accepts the invitation at block 765, the inviter is added to the user's list of contacts under the appropriate role. The inviter is notified on the inviter's network page and the contact is added to the inviter's contact list. When the registered user denies the invitation, the inviter is not added to the user's list of contacts. The inviter is notified on the inviter's network page.

If the vendor 12 selects the network tab 32, the vendor network page 64 is presented to the vendor 12 so the vendor 12 can see his or her network of mavens 14, and can search for, invite and connect with new mavens 14 in order to help in the distribution of the vendor's 12 deals. The “all contacts” tab is selected that shows all of the network contacts of the vendor 12 and displays their names, email addresses, phone numbers, and role type. If an invitation is outstanding to a prospective maven 14 the invitation can be resent. The profile of the user can be viewed, and the user can be removed from the vendor's 12 network if desired. The “invites received” tab displays a list of invitation to connect that the vendor 12 has received. For example, if a maven 14 wants to work for the vendor 12 to promote the vendor's 12 deals, this maven 14 will be displayed in the list of invites received by the vendor 12.

The vendor network page 64 also has an “invites sent” tab the selection of which displays a list and information relevant to those invites to connect sent by the vendor 12. The “groups” tab displays a list of groups of the vendor 12 that have been created by the vendor 12. The vendor 12 can invite mavens 14 into the group. The “mavens seeking vendors” tab displays a list of mavens 14 seeking vendors 12 to connect with to promote those goods/services of the vendors 12. The displayed list of the seeking mavens 14 also includes the image of the seeking maven 14, their email address, their phone number, and their location. The list also includes an action item to view a profile of the seeking maven 14, and an action item that request connection by the vendor 12 to the seeking maven 14 to add them to the deal. A search for a maven 14 field is also present in order to locate mavens 14 through entry of their name.

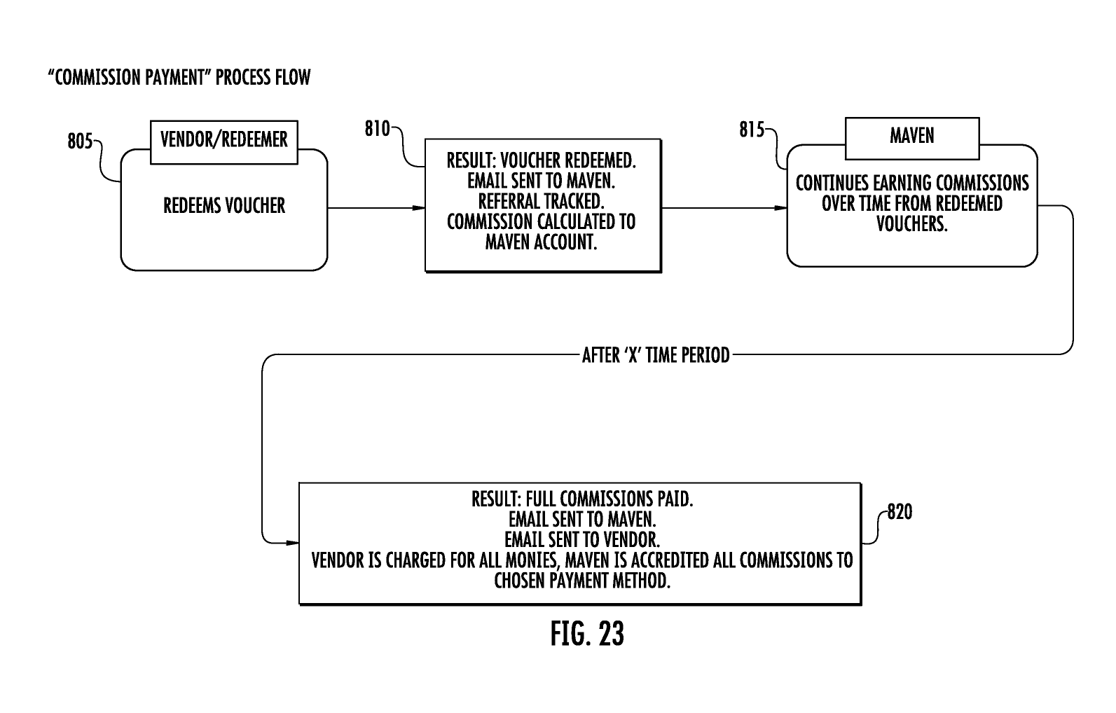

FIG. 23 is a block diagram of an exemplary “commission payment” process flow. At block 805, a vendor 12 or redeemer/staff-member 20 redeems a voucher. At block 810, an email is sent to the maven 14. The referral is tracked. A commission is calculated to/for the maven 12 account. At block 815, the maven 14 continues earning commissions over time from redeemed vouchers. After a certain period of time, at block 820, an indication that full commissions have been paid is provided to the maven 14 and the vendor 12. This indication may be provided using email, for example. The vendor 12 is charged for all monies, e.g., commissions owed by the vendor 12. The maven 14 is accredited all commissions to the chosen payment method.

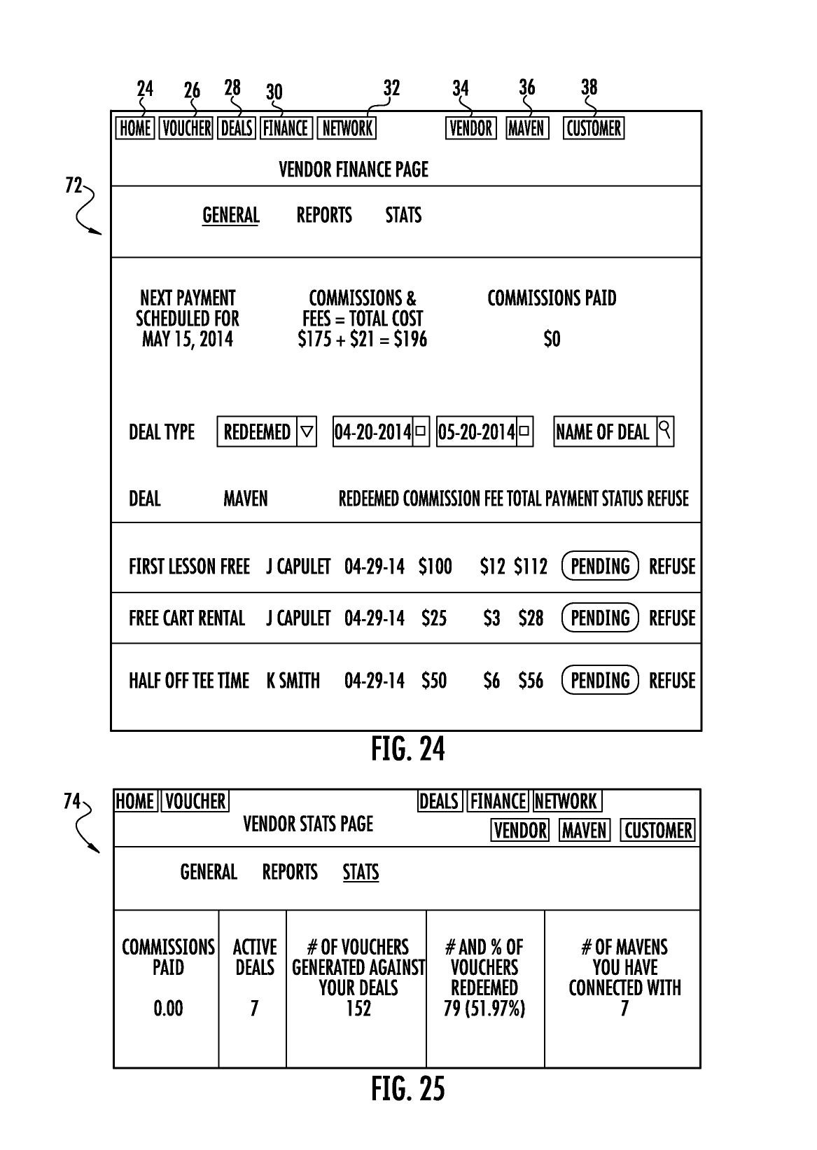

If a vendor 12 selects the finance tab 30 the vendor finance page 72 is displayed as shown in FIG. 24. From here, the vendor may select general, reports, or stats. “General” is selected in FIG. 24 which shows the date of when the next scheduled payment will occur, the total cost that is the sum of the fees to the system 10 and the commissions to mavens 14, and the amount of commissions paid to date. A list of deals can be presented by the vendor 12 first selecting whether deals that are redeem deals are to be presented, or deals that are referred deals are to be presented. Redeem deals are those in which the commission is not paid until the deal is redeemed. Referred deals are those in which a commission is paid when the deal is referred by the maven 14, regardless of whether the deal is even in fact redeemed. A third selection of “all” may be made by the vendor 12 to list both redeem and referral deal types. A date range for the displayed list can be selected, and a search field for a particular deal is provided to the user.

After the vendor 12 makes his or her selection to filter the deals, a list is displayed that includes the title of the deal, the maven 14 that redeemed a voucher on that deal, the date of redemption of the voucher, the commission owed to the maven 14, the fee to be paid to the owner of the system 10, the total of the commission and fee, and the payment status. The payment status tells the vendor 12 whether the payment has been made or is only pending. A refusal action is also available for that particular voucher redemption. If the vendor 12 refuses payment, the vendor 12 will be required to give a reason as to why payment was refused.

The payment of the vendor 12 can be done on a monthly basis, and clicking on the “reports” tab causes a report to be generated for the payment of the vendor 12, similar to a bank statement. The report may contain the date of the payment, the amount of payment, the date range of vouchers in the reporting period, the number of vouchers generate, the number of payment's made. The report can include a listing of the titles of the deals, the authentication codes, the maven 14 that facilitated the deal, and the amount of money owed for that deal.

If the vendor 12 selects the “stats” tab on the vendor finance page 72, a vendor stats page 74 is displayed as shown, for example, in FIG. 25. This page 72 shows the statistics of the vendor 12 such as the amount of commissions paid by the vendor 12, the number of active deals the vendor 12 currently has, the number of vouchers generated against the deals of the vendor 12, the number and percentage of those vouchers actually redeemed, and the number of mavens 14 that the vendor 12 has connected with. The stats may be from the start of the vendor's 12 registration with the system 10, or may be on a yearly basis, or may be stats within some set range of time.

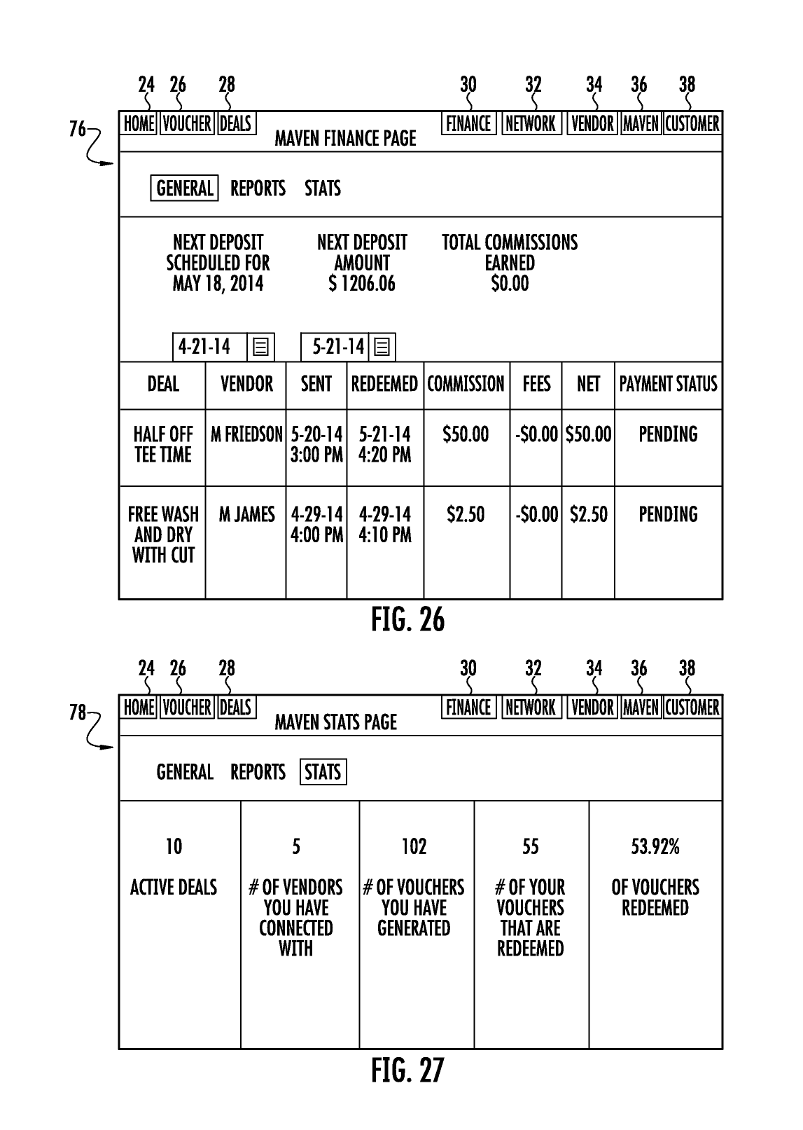

A maven 14 that selects the finance tab 30 is directed to a maven finance page 76 that has further selections of general, reports, and stats. The “general” selection is made in FIG. 26, and the date for the next deposit due the maven 14 is showed along with the amount and the total commissions earned by the maven 14. A list can be generated based upon a date range selected by the maven 14. Additionally, the maven 14 can enter a search field to search for deals or vendors 12 of the maven 14. The displayed list includes the deal, the vendor 12 of the deal, the date and time the voucher on the deal was sent, the date and time the voucher of the deal was redeemed, the commission earned on the deal, the fees due on the facilitation by the maven 14 on the deal, and the net payment due to the maven 14 (commission minus fees). The payment status is also presented which may be pending or completed.

The “reports” tab may be selected which can generate a report of the maven 14 relevant to their commissions received, deals the commission were generated, the amount of payments for the deals, authentication codes, vendor 12 of the deals, and in some instances names of customers 16.

Selection of the stats tab causes the maven stats page 78 to be displayed as shown in FIG. 27. This page 78 shows the number of active deals the maven 14 is working on at the time the stats page 78 is pulled up, the number of current vendors 12 that the maven 14 is connected with (whether within a set time period or the cumulative total of the maven 14), the number of vouchers that the maven 14 has generated (whether within a set time period or the cumulative total of the maven 14), the number of vouchers that were redeemed (whether within a set time period or the cumulative total of the maven 14), and the percentage of vouchers redeemed which is the percentage of the previous two statistics.

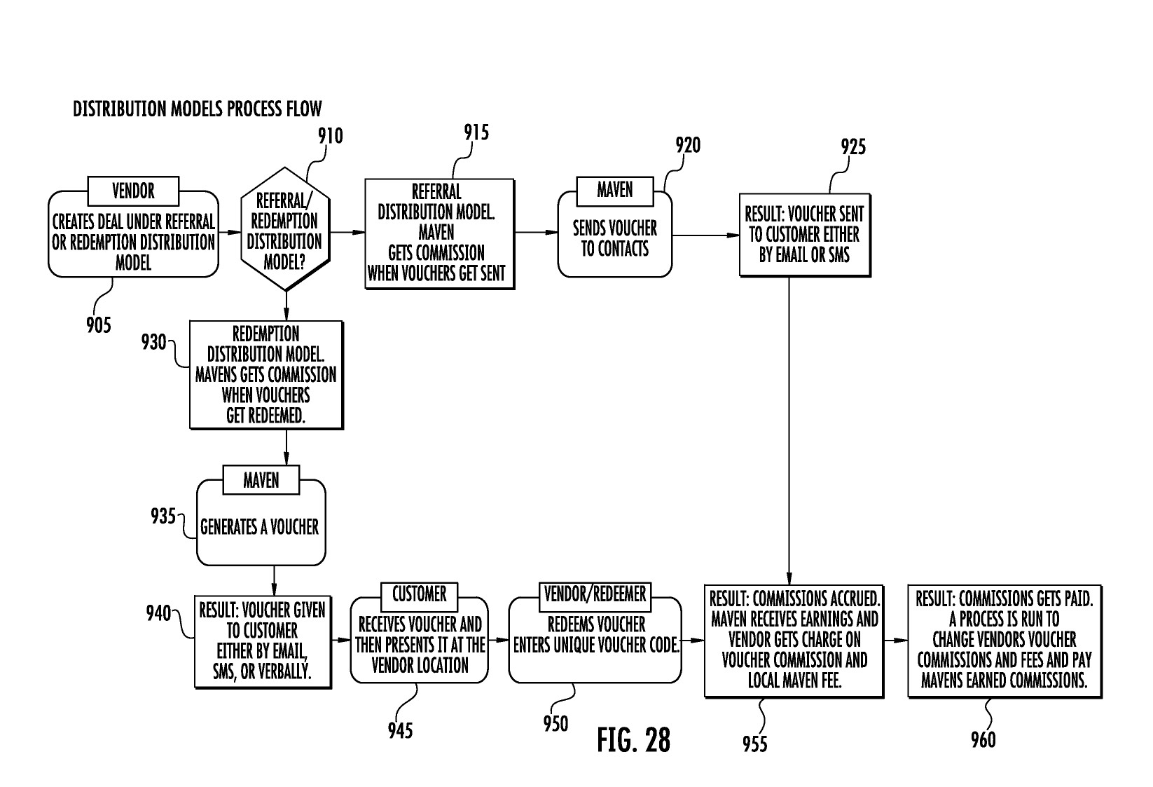

FIG. 28 is a block diagram of an exemplary “distribution models” process flow. This example process flow shows a high-level view of processes that can be used once a deal is created. At block 905, a vendor 12 creates a deal. The deal may be created under a referral distribution model or a redemption distribution module. The vendor 12 determines which distribution module is used at block 910. The referral distribution module is selected at block 915. When the referral distribution module is utilized, the Maven(s) 14 receive(s) a commission (or other compensation) when vouchers are sent. At block 920, the maven(s) 14 send a voucher to their contacts. At block 925, a voucher is sent to the customer 16, either by email or SMS.

The redemption distribution module is selected at block 930. When the redemption distribution module is utilized, the maven(s) 14 receive(s) a commission (or other compensation) when vouchers are redeemed. At block 935, the maven 14 generates a voucher. At block 940, a voucher is given to the customer 16. The voucher may be given to the customer 16 verbally, or by using email or SMS. At block 945, the customer 16 receives the voucher and presents the voucher at the vendor 12 location. At block 950, the vendor 12 or redeemer 20 redeems the voucher by entering the unique voucher code. At block 955, commissions (or other compensation) are accrued from the referral distribution module and/or the redemption distribution module. Earnings are accrued for each maven 14. Charges on voucher commissions and local maven fees are accrued for each vendor 12. At block 960, commissions are paid. A process is run periodically, e.g., every Sunday, to charge voucher commissions and fees to the vendors and pay earned commissions to the mavens 14.

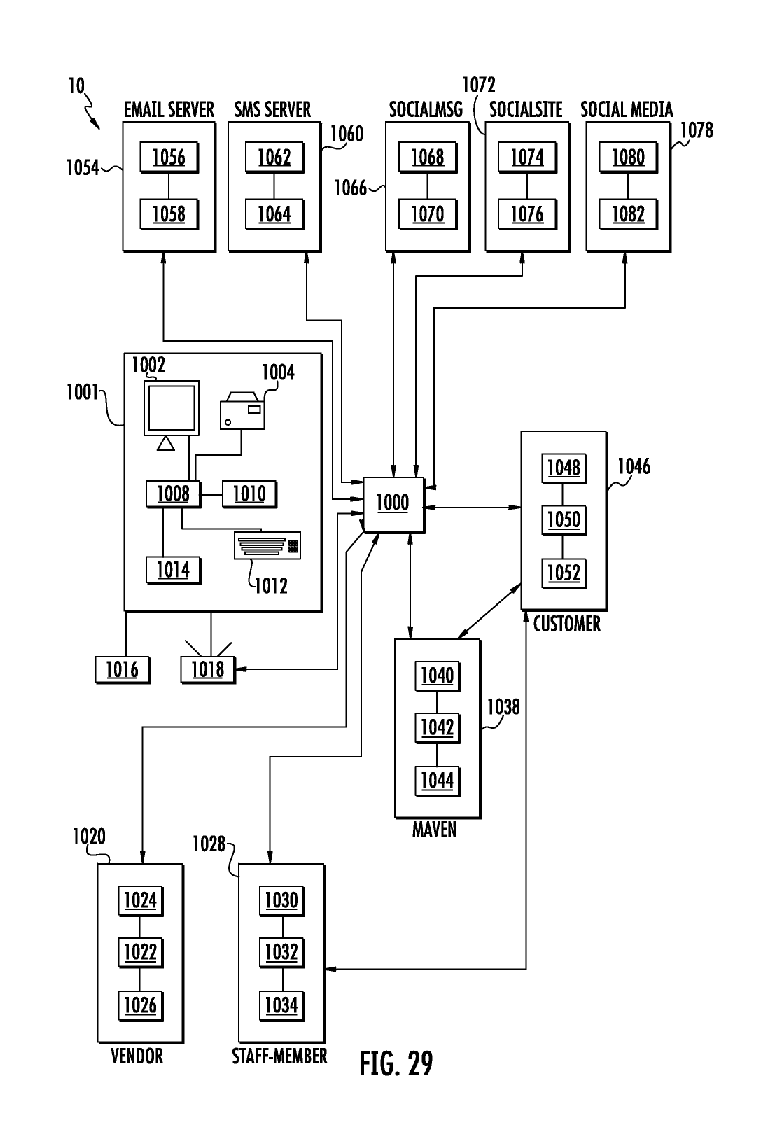

The machine based system 10 previously discussed may be carried out by a computer or by a series of computers and other types of hardware connected to one another through a network 1000 in accordance with certain exemplary embodiments. FIG. 29 illustrates a machine based system 10 constructed and arranged to execute and manage the system for facilitating deals 10. Various user computer systems such as a platform computer 1001, a vendor computer 1020, a maven computer 1038, and a customer computer 1046 are illustrated. Either one of, or all, of the user computer systems 1001, 1020, 1038, and 1046 can be used by the user to implement the machine based system 10. A platform computer 1001 includes a platform processor 1008 that is in communication with a platform memory 1010, a platform display 1002, and an interface card 1014. This particular platform computer 1001 may be, for example, a PC located in the business of an administrator of the machine based system 10. The platform processor 1008, and other processors described herein, may be a piece of hardware that can execute readable machine instructions for performing various steps and functions. The processor 1008 may include but need not be limited to a microprocessor, a computer server, a digital signal processor, or combinations thereof. The platform processor 1008 may comprise one or more processors, which may comprise part of a single machine or multiple machines. The processor 1008 is not a signal, but is instead a physical object. A keyboard 1012, which is a piece of physical hardware, may be part of the platform computer 1001 and the user may use the keyboard 1012 to send instructions to the processor 1008 to implement the facilitation of deals. The display 1002 may be a piece of hardware. Further, the display 1002 can be a graphical user interface in accordance with certain exemplary embodiments.

The platform memory 1010 may be solid state memory, random access memory, and/or a database in accordance with different embodiments. The memory 1010 may be a physical object and does not include signals. Instructions for implementing the machine based system 10 can be included on the memory 1010, and the platform computer 1001 may function to operate various portions of the machine-based system 200. The platform processor 1008 and the platform memory 1010 are not executable applications but instead are hardware that are operable for carrying out instructions. A platform printer 1004 is also in communication with the processor 1008 and can be used to print out reports or other documents such as the vendor stats page 74 or maven stats page 78 of the vendor 12 or maven 14 as previously discussed. The platform processor 1008 can read the memory 1010 and display this information on the platform display screen 1002. The platform printer 1004 and the display screen 1002 are pieces of hardware that are located in the machine-based system 10. Interface card 1014 can be in communication with a router 1018 or other device to allow for communication with a network 1000. Network 1000 could be a public switched telephone network, the internet, or a local area network in accordance with certain exemplary embodiments. Instead of physically touching and using the platform computer 1001, a user of the system 10 such as the vendor 12 may have a vendor computer 1020 that includes a vendor processor 1022, vendor memory 1024, and a vendor display 1026. The vendor computer 1020 may be a mobile device such as a PDA, cell phone, or smart phone. The vendor memory 1024 may have an application stored thereon that allows the vendor 12 to implement the machine-based system 10. The mobile app previously discussed may be stored on the vendor memory 1024. The vendor mobile device display 1026 may be a touch screen that allows the user to both view information and input information through a series of soft keys. The vendor mobile device processor 1022 is in communication with the vendor mobile device memory 1024 and the mobile device display 1026, and the vendor computer 1020 may be connected to the network 1000 to receive information from and to send information to other items of the machine based system 10. Instead of being a mobile device, the vendor computer 1020 may be a desktop PC in other arrangements. The vendor 12 uses the vendor computer 1020 to access other portions of the machine based system 10 to cause invitations to be sent, deals to be created, and money to be transferred.

The redeemer/staff member 20 can be provided with a staff member computer 1028, that may be a mobile or desktop PC, for use in accessing the machine based system 10 in order to enter redemption codes provided to him or her for the deals. The staff member computer 1028 has a staff member memory 1030 in communication with a staff member processor 1032, and a staff member display. Again, other hardware as previously discussed may be incorporated. The staff member computer 1028 is in communication with the other components of the machine-based system 10 via the network 1000 connection to the processor 1032.

The maven 14 can be provided with a mobile device or a desktop device such as a maven computer 1038. The computer 1038 has a maven processor 1042 in communication with a maven memory 1040. A maven display 1044 is present to present information to the maven 14 or to function as an input device. The maven computer 1038 may communicate with other components of the machine based system 10 over the network 1000 such as the platform computer 1001, vendor computer 1020, or FACEBOOK® server 1066. The maven 14 can use the maven computer 1038 to access the system 10 to list deals, accept invitations from vendors 12, and contact customers 16.

The system 10 also has a customer computer 1046 that the customer 16 can control to access the system 10 to view deals and receive vouchers for redemption. The customer computer 1046 has a customer memory 1048 in communication with a customer processor 1050. A customer display 1052 is also present to allow the customer 16 to view information and input commands. The customer computer 1046 may access and communicate with other portions of the system 10 such as the platform computer 1001, the staff member computer 1028, or the maven computer 1038. The customer computer 1046 may directly communicate with the maven computer 1038 or the staff member computer 1028 through a hardwired connection in some embodiments without the use of the network 1000. Alternatively, the customer 16 can verbally communicate the redemption code to the staff member 20.

The machine based system 10 can determine the location of the customer computer 1046, and hence the customer 16 through the use of GPS or cellular network provider geographical location capabilities (GLC) of the network provider. If the customer computer 1046 is a mobile device, the system 10 can track with GPS/GLC the customer computer 1046 at various locations. A mobile application of the system 10 can be installed onto the customer computer 1046 in order to allow this functionality. With the mobile application installed, the system may be capable of determining the location of the customer computer 1046, however the mobile application need not be installed onto the customer computer 1046 in other embodiments. If the machine based system 10, for example the platform computer 1001, knows the location of the customer computer 1046, this information may be used in order to determine redemption of the customer 16 of a deal because it will be known that the customer 16 was present at a specific location for this redemption.

The machine based system 10 also has other pieces of hardware such as an email server 1054 that has an email memory 1056 in communication with an email processor 1058. Additionally, an SMS server 1060 is present that has an SMS memory 1062 in communication with an SMS processor 1064. The platform computer 1001 may send a command to the email server 1054 or SMS server 1060 to cause one or both to send a communication to the customer computer 1046 to inform them of a deal or provide them with a voucher redemption code. The email server 1054 and SMS server 1060 can communicate with other components of the system 10 such as the vendor computer 1020, maven computer 1038, or platform computer 1001.

Also included is a TWITTER® server 1066 that has a TWITTER® processor 1068 in communication with a TWITTER® memory 1070. A FACEBOOK® server 1072 includes a FACEBOOK® memory 1076 in communication with a FACEBOOK® processor 1074. The system 10 may also include a social media server 1078 that has a social media memory 1080 in communication with a social media processor 1082. The maven computer 1038 can access any one of or all of the servers 1066, 1072, and 1078 in order to place an announcement thereon that functions to promote the deal of the vendor 12. Codes or links to the deal can be placed on the various servers 1066, 1072, or 1078, thus directing the customer computer 1046 to the platform computer 1001 for the generation of the voucher.

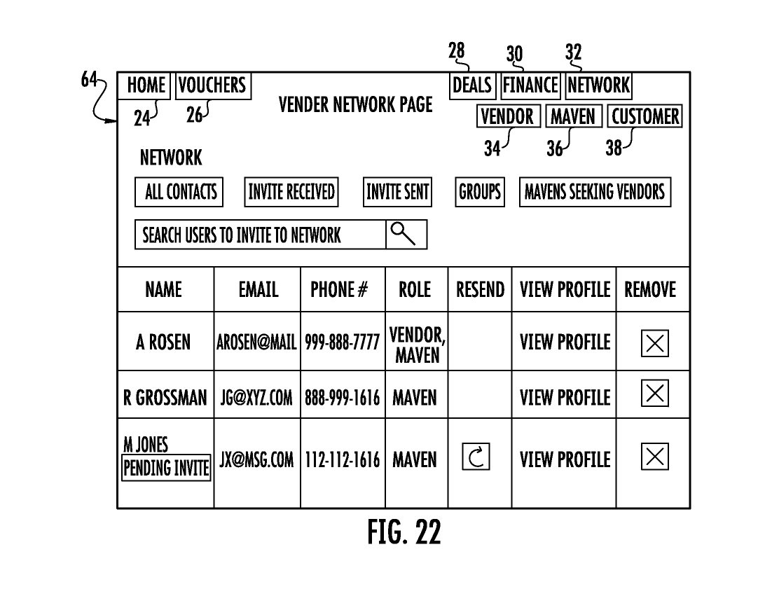

Various elements, such as software and data, can be stored in any one of or multiple ones of the memories 1010, 1024, 1030, 1040, or 1048. The deal information, voucher information, reporting documents, and network connections may be stored on any one of or various ones of the memories 1010, 1024, 1030, 1040, or 1048. The various processors 1008, 1022, 1032, 1042, and 1050 can access information stored in the memories 1010, 1024, 1030, 1040, or 1048 and can transfer this information to other ones of the processors 1008, 1022, 1032, 1042, and 1050. Although single processors and memories are disclosed as making up the various computers and servers 1001, 1020, 1028, 1038, and 1046, in other arrangements multiple processors and memories may be present. Further, multiple computers and servers may make up the various computers and servers 1001, 1020, 1028, 1038, and 1046 and they need not each be made up of a single computer or server. The various instructions, software, data, and interactions discussed with reference to FIGS. 1-28 can be implemented on the processors and memories discussed in relation to the particular computer or server 1001, 1020, 1028, 1038, and 1046 that implements the stated instructions, software, data or interactions of the process of the machine-based system 10. The machine-based system 10 may include a physical report 1016, that is obtained by use of the printer 1004.

The methods and systems described herein can be executed through instructions contained in non-transitory tangible computer readable storage medium. The various memories 1010, 1024, 1030, 1040, or 1048 previously discussed may be this type of memory. The computer readable medium may be an article of manufacture having the capability to store one or more computer programs, one or more pieces of data, or a combination thereof. The computer readable medium may include a computer memory, hard disk, memory stick, magnetic tape, floppy disk, optical disk (CD or DVD), zip drive, solid-state drive, or combinations thereof. The memories described herein may physically change when data is written to the memories such that there is a physical transformation of the memories upon execution of the article of manufacture. The computer readable medium is not a signal and is not and does not include transitory propagating signals. The computer readable medium is not a modulated data signal such as a carrier wave.

The instructions may cause the various processors 1008, 1022, 1032, 1042, and 1050 to perform certain steps as discussed. All of the methods and alternate methods can be carried out in a system using instructions on non-transitory computer readable medium executed by one or more processors. The machine-based system and computer readable medium and the article of manufacture, and methods, disclosed herein require and are limited to use in some manner with a computer. The machine-based system and the article of manufacture and the computer readable medium, and methods, disclosed herein do not include transitory embodiments.

The following example explains the implementation of the machine based system 10 in facilitating a deal. A concierge (maven 14) at a hotel in Miami refers customers 16 to eat at a local restaurant 12. The maven 14 and the vendor 12 can negotiate a deal with specific value characteristics for a customer 16 and the specific compensation valuation to the maven 14. The inventive platform 10 allows the concierge 14 to sign up as a maven 14 and provide a voucher to the customer 16, via email, SMS, verbally, or in print. The customer 16 can redeem the voucher for a discount or other promotional item, such as a free drink or appetizer. The platform 10 allows the vendor 12 to create a deal and to define many deal details that can be generic in nature and may be offered to a large group of mavens 14 or only to a specific maven 14. Compensation is provided to the concierge 14, for example, when the customer(s) 16 attends the restaurant 12 and eats. The compensation can take various forms, but this payment happens “offline” away from the customer 16 such that the customer 16 is not aware of the fact that a payment transaction was made between the customer 16 and the maven 14. Keeping the customer 16 unaware of this exchange may function to eliminate the potential of negative customer satisfaction. In parallel, the vendor 12 can track online which maven 14 referred the customer 16 and what customer 16 actually redeemed the voucher. In addition, the vendor 12 is able to track if the maven 14 simply provided a generic referral code.

The system 10 also allows for the use of common word(s) or phrase(s) to be used as a referral code where each common word or phrase(s) can represent a unique referral code for a specific deal that can be used concurrently for multiple deals but will be unique to the specific deal for the duration of that deal.

The system 10 may provide all of the players, e.g., maven 14, vendor 12, or customer 16 to sign up directly and have multiple roles, and to create multiple relationships using multiple roles with any number of different deal counterparts.

The present 10 platform may uniquely charge a fee based on SMS sent and vouchers redeemed, but can also provide the service on a monthly service fee basis or via a one-time or recurring licensing fee. Although described as creating the deal, the vendor 12 need not create the deal in other embodiments. For example, the maven 14 can be the user that creates the deal in certain exemplary embodiments of the system 10. Also, although the deal has been described as providing an incentive to the customer 16 to accept the deal, in other versions of the system 10 the deal need not provide an incentive to the customer 16 for acceptance of the deal. In these arrangements, the deal may function simply as an advertisement of the vendor's 12 goods or services and upon acceptance of the deal, the customer 16 will receive the same return as those customers not aware of or using the deal. The maven 14 may connect with the customer 16 for the distribution of the deal through face to face communication, email, FACEBOOK®, or any social medial platform. The voucher may be in the form of a SMS message, an oral communication, a hard copy paper letter, or an email in various arrangements.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed:

1. A machine based system for facilitating deals, comprising:
a memory for storing a list of mavens that assist a vendor in the facilitation of a deal, wherein the list of mavens includes at least one maven that is not an existing customer of the vendor, wherein a voucher for redemption is generated that has information on the deal; and
a processor that determines that the voucher has been redeemed, wherein the processor assigns a commission, wherein the deal includes an incentive for a customer that redeems the voucher.

2. The machine based system as set forth in claim 1, wherein the processor generates the voucher, wherein the maven sends the voucher to the customer.

3. The machine based system as set forth in claim 1, wherein the processor generates the voucher, wherein the maven sends a link to the customer that is accessed by the customer, wherein accessing the link causes the processor to generate the voucher.

4. The machine based system as set forth in claim 1, wherein the processor assigns the commission when the voucher is redeemed.

5. The machine based system as set forth in claim 1, further comprising:
a first distribution site onto which information about the deal is placed by the maven for purposes of being communicated for facilitation of the deal; and
a second distribution site different than the first distribution site onto which information about the deal is placed by the maven for purposes of being communicated for facilitation of the deal.

6. The machine based system as set forth in claim 5, wherein the first distribution site is TWITTER® and wherein the second distribution site is FACEBOOK®.

7. The machine based system as set forth in claim 1, wherein the memory has a list of sub-mavens that assist the maven in the facilitation of the deal, wherein the processor assigns a first portion of the commission to the maven and a second portion of the commission to the sub-maven of the list that communicates to the customer that redeems the voucher.

8. The machine based system as set forth in claim 1, wherein the memory has a redeemer that assists the vendor in the facilitation of the deal, wherein the customer communicates the voucher to the redeemer, wherein the processor receives a redemption code entered by the redeemer and authenticates the voucher to facilitate redemption of the voucher by the customer.

9. The machine based system as set forth in claim 1, wherein the deal is an exclusive deal, wherein the processor assigns a first and last name of the customer to the voucher, wherein the maven sends the voucher to the customer through a mode of communication that is not TWITTER® or FACEBOOK®.

10. A machine based system for facilitating deals, comprising:
a memory for storing a deal of a vendor, wherein a maven assists the vendor in facilitation of the deal, wherein the deal includes an incentive for a customer; and
a processor that assigns a deal type to the deal, wherein the deal type is selected from a group of deal types that include a viral deal type in which the deal is allowed to be shared on FACEBOOK® and TWITTER®, and a non-exclusive deal type in which the deal is not allowed to be shared on FACEBOOK® and TWITTER®, wherein the non-exclusive deal type does not require the first and last name of the customer.

11. The machine based system as set forth in claim 10, wherein the group of deal types includes an exclusive deal type in which the deal is not allowed to be shared on FACEBOOK® and TWITTER®, wherein the exclusive deal type requires the first and last name of the customer.

12. The machine based system as set forth in claim 10, wherein the non-exclusive deal type is assigned by the processor, wherein the maven communicates the deal to the customer by a method of communication selected from the group consisting of in person, SMS message, and email.

13. The machine based system as set forth in claim 10, wherein the maven is not an existing customer of the vendor, wherein the processor generates a voucher for redemption that has information on the deal, wherein the processor assigns a commission to the maven, wherein the processor determines that the voucher has been redeemed.

14. The machine based system as set forth in claim 10, wherein the viral deal type is assigned by the processor, and further comprising:
a first distribution site onto which information about the deal is placed by the maven for purposes of being communicated for facilitation of the deal, wherein the first distribution site is TWITTER®; and
a second distribution site different than the first distribution site onto which information about the deal is placed by the maven for purposes of being communicated for facilitation of the deal, wherein the second distribution site is FACEBOOK®.

15. The machine based system as set forth in claim 15, wherein the maven communicates the deal to the customer through in person communication.

16. A machine based system for facilitating deals, comprising:
a memory for storing a deal of a vendor, wherein a maven assists the vendor in facilitation of the deal, wherein the deal includes an incentive for a customer, wherein a voucher for redemption is generated that has information on the deal;
a processor that determines that the voucher has been redeemed;
a first distribution site onto which information about the deal is placed by the maven for purposes of being communicated for facilitation of the deal, wherein the first distribution site is a social media site; and
a second distribution site different than the first distribution site onto which information about the deal is placed by the maven for purposes of being communicated for facilitation of the deal, wherein the second distribution site is a social media site.

17. The machine based system as set forth in claim 16, wherein the processor generates the voucher, wherein the information about the deal that is placed by the maven on the first distribution site is the voucher, wherein the information about the deal that is placed by the maven on the second distribution site is the voucher.

18. The machine based system as set forth in claim 16, wherein the first distribution site is TWITTER®, and wherein the second distribution site is FACEBOOK®, and further comprising a third distribution site that is a social media site, wherein the maven additionally communicates the deal for purposes of facilitation by a method of communication selected from the group consisting of in person, SMS message, and email.

19. The machine based system as set forth in claim 16, wherein the processor assigns a commission to the maven when the voucher is redeemed.

20. The machine based system as set forth in claim 16, further comprising:
a customer memory that has a mobile application stored thereon; and
a customer processor in communication with the customer memory, wherein the customer memory and the customer processor are part of a mobile device of the customer, wherein the location of the mobile device of the customer is communicated to the processor of the machine based system for use in determining redemption of the voucher.
